(19) United States
(12) Patent Application Publication
(10) Pub. No.: US 2026/0303320 A1
(43) Pub. Date: Oct. 1, 2026

(54) SYSTEMS AND METHODS FOR SECURE DISTRIBUTED EXECUTION OF MACHINE LEARNING MODELS USING GRAPH LEVEL PARTITIONING AND ENCRYPTION

(71) Applicants: Constructor Technology AG, Schaffhausen (CH); Constructor Education and Research Genossenschaft, Schaffhausen (CH)

(72) Inventors: Alexander Tormasov, Bremen (DE); Serg Bell, Singapore (SG); Stanislav Protasov, Singapore (SG); Nikolay Dobrovolskiy, Alanya (TR); Laurent Dedenis, Geneve (CH)

(21) Appl. No.: 19/678,447

(22) Filed: May 15, 2026

Related U.S. Application Data
(63) Continuation-in-part of application No. 19/399,724, filed on Nov. 25, 2025.
Application No. 19/399,724 is a continuation-in-part of application No. 19/169,111, filed on Apr. 3, 2025, now Pat. No. 12,500,735.
(60) Provisional application No. 63/575,099, filed on Apr. 5, 2024.

(51) Int. Cl. H04L 9/00; G06N 3/0495

(52) U.S. Cl. CPC H04L 9/008; G06N 3/0495

(57) ABSTRACT

A system generates a computational graph from machine learning model operations, creating multiple operation nodes with defined data dependencies. For each operation node, the system determines compatibility with a specific encryption scheme. Based on this compatibility, the system partitions the operation nodes into two groups: one group includes nodes compatible with the encryption scheme, while the other includes node(s) incompatible with the scheme. The system then produces an execution plan specifying that a server will execute operations from the compatible group using the encryption scheme on encrypted data, and a client device will execute operations from the incompatible group on unencrypted data. Execution of the machine learning model follows this plan.

### CROSS-REFERENCE TO RELATED APPLICATIONS

This application is a continuation-in-part application that claims priority to U.S. Non-Provisional application Ser. No. 19/399,724, filed Nov. 25, 2025, which is a continuation-in-part application that claims priority to U.S. Non-Provisional application Ser. No. 19/169,111, filed Apr. 3, 2025, which further claims the benefit of United States Provisional Application No. 63/575099, filed Apr. 5, 2024, all of which are herein incorporated by reference.

### FIELD OF TECHNOLOGY

The present disclosure relates to the field of machine learning (ML), and more specifically to secure distributed execution of ML models using graph-level partitioning under restricted cryptographic capabilities.

### BACKGROUND

Machine learning inference for large models is increasingly performed in client-server architectures, where a client device supplies user-specific inputs and a remote server executes performance-critical portions of the model. To maintain confidentiality of user data, prior systems employ encryption during remote execution, including homomorphic encryption that allows computation over ciphertexts. However, many practical encryption schemes available at inference time are partially homomorphic and permit only a restricted set of operations, such as addition or scalar multiplication by plaintext constants, but not general non-linear or multiplicative operations. Conventional approaches often determine encryption compatibility at the level of individual operations during execution, incurring frequent encryption/decryption boundaries, excessive network round trips, and redundant homomorphic computation, thereby degrading latency and increasing cost.

### SUMMARY

The present disclosure relates to privacy-preserving and secure distributed computation for machine learning systems. More specifically, the present disclosure concerns systems and methods for graph-level analysis, partitioning, and execution of machine-learning workloads—including, without limitation, neural networks, large language models, and quantized or sparsified variants—in heterogeneous client-server or multi-node environments.

The techniques apply to deployments that utilize constrained cryptographic or trusted-execution primitives, such as partially or fully homomorphic encryption (including additive or leveled schemes), secure enclaves or trusted execution environments (TEEs), and secure multi-party computation, to enable confidential inference (and in certain aspects, training) while reducing computational and communication overhead.

In an exemplary aspect, the techniques described herein relate to a method for secure distributed processing of data, the method including: generating, based on operations performed by a machine learning model (MLM), a computational graph including a plurality of operation nodes and data dependencies between the plurality of operation nodes; for each respective operation node of the plurality of operation nodes, determining whether a respective operation represented by the respective operation node is compatible with an encryption scheme; partitioning the plurality of operation nodes of the computational graph into a plurality of operation groups based on compatibility of the plurality of operation nodes with the encryption scheme, wherein a first group of the plurality of operation groups includes operation nodes that are compatible with the encryption scheme and a second group of the plurality of operation groups includes operation nodes that are incompatible with the encryption scheme; generating an execution plan that indicates that operations associated with the first group are to be executed by at least one server using the encryption scheme on encrypted data and that operations associated with the second group are to be executed by at least one client device on unencrypted data; and executing the MLM based on the execution plan.

In some aspects, the techniques described herein relate to a method, wherein executing the MLM based on the execution plan includes executing each operation associated with the first group at the at least one server over the encrypted data using homomorphic operations of the encryption scheme and executing each operation associated with the second group at the at least one client device on the unencrypted data.

In some aspects, the techniques described herein relate to a method, wherein determining whether the respective operation is compatible with the encryption scheme is based at least part on which arithmetic operations are supported homomorphically by the encryption scheme.

In some aspects, the techniques described herein relate to a method, wherein the encryption scheme is a partially homomorphic encryption (PHE) scheme that supports homomorphic addition of ciphertexts corresponding to addition of plaintext values.

In some aspects, the techniques described herein relate to a method, wherein the MLM is a 1-bit large language model (LLM), and at least one first operation group includes operations of a 1-bit linear layer whose weights are quantized to 1-bit precision.

In some aspects, the techniques described herein relate to a method, wherein partitioning the plurality of operation nodes into the plurality of operation groups includes: identifying, along at least one dataflow path in the computational graph, a maximal contiguous sequence of operation nodes that are compatible with the encryption scheme; and defining the maximal contiguous sequence as the first group such that extending the sequence with an adjacent operation node would introduce an operation node that is incompatible with the encryption scheme.

In some aspects, the techniques described herein relate to a method, further including: identifying, within the computational graph, at least one subgraph whose outputs depend only on model parameters or constants and not on user-specific input data; precomputing one or more outputs of the at least one subgraph as precomputed values; and using the precomputed values when executing operations of the plurality of operation groups without recomputing the outputs for each inference.

In some aspects, the techniques described herein relate to a method, wherein determining whether the respective operation is compatible with the encryption scheme includes determining whether the respective operation can be expressed as a combination of primitive operations that are supported homomorphically by the encryption scheme.

In some aspects, the techniques described herein relate to a method, wherein the second group includes at least one operation that uses a non-linear transformation that is not directly supported by the encryption scheme, the non-linear transformation including one of: a normalization operation, an exponential function, a Softmax function, or a square root operation.

In some aspects, the techniques described herein relate to a method, further including: encrypting, at the at least one client device, one or more intermediate values that serve as inputs to the first group before execution of the first group at the at least one server; transmitting the encrypted intermediate values to the at least one server; and decrypting, at the at least one client device, encrypted intermediate results produced by the at least one server for use as inputs to the second group.

In some aspects, the techniques described herein relate to a method, wherein executing operations of the first group at the at least one server includes executing at least one of: a matrix-vector operation, a linear projection, or an additive accumulation using a homomorphic addition operation supported by the encryption scheme.

In some aspects, the techniques described herein relate to a method, further including: caching, at the at least one client device: a result associated with at least one selected operation group, the cached result being associated with a cache key that depends on an identifier of the selected operation group, and an input state to the selected operation group; determining, for a subsequent execution of the MLM, whether a cache includes the cached result for the cache key corresponding to a current input state of the selected operation group; and when the cached result is present in the cache, reusing the cached result without executing the selected operation group according to the execution plan.

In some aspects, partitioning the computational graph includes identifying a first subgraph whose computations depend on base-model parameters and a second subgraph whose computations depend on tenant-specific adaptation parameters, and the execution plan assigns the first subgraph to server-side execution and assigns the second subgraph to a selectively encrypted branch within the computational graph.

In some aspects, the execution plan specifies a plurality of successive transfers between graph-stage boundaries, including transmitting a first intermediate representation to the at least one server for execution of a first linear stage, receiving a transformed representation from the at least one server, and separately executing and exchanging a reduced-dimension adaptation-branch representation for a tenant-specific adaptation stage.

In some aspects, determining whether the respective operation represented by the respective operation node is compatible with an encryption scheme includes classifying a first set of nodes as executable under an additive homomorphic scheme, classifying a second set of nodes as executable under a lookup-based homomorphic scheme, and classifying a third set of nodes as executable under an approximate or multiplicative homomorphic scheme.

In some aspects, the computational graph includes an attention node that is incompatible with the encryption scheme in an original form, and generating the execution plan includes replacing or designating the attention node as a kernel-based attention node having an implementation more compatible with encrypted execution.

It should be noted that the methods described above may be implemented in a system comprising at least one hardware processor and memory. Alternatively, the methods may be implemented using computer executable instructions of a non-transitory computer readable medium.

In some aspects, the techniques described herein relate to a system for secure distributed processing of data, the system including: at least one memory; and at least one hardware processor coupled with the at least one memory and configured, individually or in combination, to: generate, based on operations performed by a machine learning model (MLM), a computational graph including a plurality of operation nodes and data dependencies between the plurality of operation nodes; for each respective operation node of the plurality of operation nodes, determine whether a respective operation represented by the respective operation node is compatible with an encryption scheme; partition the plurality of operation nodes of the computational graph into a plurality of operation groups based on compatibility of the plurality of operation nodes with the encryption scheme, wherein a first group of the plurality of operation groups includes operation nodes that are compatible with the encryption scheme and a second group of the plurality of operation groups includes operation nodes that are incompatible with the encryption scheme; generate an execution plan that indicates that operations associated with the first group are to be executed by at least one server using the encryption scheme on encrypted data and that operations associated with the second group are to be executed by at least one client device on unencrypted data; and execute the MLM based on the execution plan.

In some aspects, the techniques described herein relate to a non-transitory computer readable medium storing thereon computer executable instructions for secure distributed processing of data, including instructions for: generating, based on operations performed by a machine learning model (MLM), a computational graph including a plurality of operation nodes and data dependencies between the plurality of operation nodes; for each respective operation node of the plurality of operation nodes, determining whether a respective operation represented by the respective operation node is compatible with an encryption scheme; partitioning the plurality of operation nodes of the computational graph into a plurality of operation groups based on compatibility of the plurality of operation nodes with the encryption scheme, wherein a first group of the plurality of operation groups includes operation nodes that are compatible with the encryption scheme and a second group of the plurality of operation groups includes operation nodes that are incompatible with the encryption scheme; generating an execution plan that indicates that operations associated with the first group are to be executed by at least one server using the encryption scheme on encrypted data and that operations associated with the second group are to be executed by at least one client device on unencrypted data; and executing the MLM based on the execution plan.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1A is a block diagram of an exemplary secure local LLM deployment in an enterprise.

FIG. 1B is a block diagram of an exemplary secure hosted LLM deployment for an enterprise.

FIG. 2 is a block diagram of exemplary functional modules of the secure LLM deployment for an enterprise.

FIG. 3 illustrates a method for providing a secure LLM deployment in an enterprise.

FIG. 4 illustrates an example of a method for providing a secure LLM deployment in an enterprise using encryption and Access Control List (ACL).

FIG. 5 is a block diagram of an encoder and decoder-based architecture on which encryption is performed.

FIG. 6 is a block diagram of a multi-head attention block.

FIG. 7 is a block diagram of a generalized example for performing LLM operations using a client device and a service provider.

FIG. 8 illustrates another method for securely executing an MLM.

FIG. 9 is a block diagram depicting an operations graph extraction and encryption scheme profiling pipeline for a MLM, including graph-level compatibility analysis and operation group partitioning.

FIG. 10 is a block diagram depicting identification and precomputation of parameter-only subgraphs within the computational graph of MLM operations.

FIG. 11 is a block diagram depicting runtime execution of first operation groups in a distributed encrypted form using the updated execution plan.

FIG. 12 is a block diagram depicting runtime execution of second operation groups and iterative transitions between first and second operation groups in the distributed encrypted form.

FIG. 13 is a block diagram depicting optional client-side caching of group-level results at operation group boundaries.

FIG. 14 is a flow diagram of a method for secure distributed execution of ML models using graph-level partitioning under restricted cryptographic capabilities.

FIG. 15 presents an example of a general purpose computer system on which aspects of a secure LLM deployment in an enterprise can be implemented.

### DETAILED DESCRIPTION

Exemplary aspects are described herein in the context of a system, method, and a computer program for providing a secure large language model (LLM) deployment in an enterprise IT environment. Those of ordinary skill in the art will realize that the following description is illustrative only and is not intended to be in any way limiting. Other aspects will readily suggest themselves to those skilled in the art having the benefit of the disclosure. Reference will now be made in detail to implementations of the example aspects as illustrated in the accompanying drawings. The same reference indicators will be used to the extent possible throughout the drawings and the following description to refer to the same or like items.

In an exemplary aspect, a method for secure distributed processing of data is provided. The method comprises determining whether a first operation of a distributed machine learning model should be executed on at least one server or on at least one client device based on one or more criteria including compatibility with specific encryption schemes, computational load distribution, and associated expense considerations. In response to a determination that the first operation should be executed on the at least one server, the method further comprises encrypting data associated with the first operation using a specific encryption scheme and transmitting the encrypted data to the at least one server for execution of the first operation on the encrypted data. In response to a determination that the first operation should be executed on the at least one client device, the method comprises performing the first operation on the data using the at least one client device without encrypting the data using the specific encryption scheme.

The method enables explicit control over placement of computational load between server-side and client-side resources, allowing selection of execution location to reflect encryption compatibility, throughput requirements, latency constraints, energy consumption preferences, and cost models associated with network transfer and compute usage. Encryption of server-bound data using the specific encryption scheme provides confidentiality during transit and server-side processing, while local execution on the at least one client device without application of the specific encryption scheme reduces overhead when encryption is unnecessary under the selected load distribution and cost profile. The method thereby facilitates secure, configurable, and cost-aware execution of distributed machine learning operations across heterogeneous infrastructure.

The present disclosure describes a secure 1-bit distributed LLM that offers security and computational efficiency. In general, a 1-bit LLM refers to a type of neural network model where the weights and possibly the activations are quantized to 1-bit precision. This means that instead of using the typical 32-bit or 16-bit floating-point numbers to represent the weights and activations, the model uses binary values (0 or 1). This quantization can significantly reduce the memory footprint and computational requirements of the model, making it more efficient in terms of storage and processing.

By using 1-bit precision, the amount of memory required to store the weights of the model is drastically reduced. This can be particularly beneficial for deploying large models on devices with limited memory, such as mobile phones or edge devices. The overall size of the model is also much smaller compared to traditional models with higher precision weights.

Furthermore, operations involving 1-bit values are generally faster and require less power compared to operations involving higher precision values. This can lead to faster inference times and lower energy consumption. The reduced precision can simplify the hardware requirements, allowing for the use of specialized hardware accelerators designed for binary operations.

In particular, 1-bit LLMs are well-suited for deployment on edge devices (e.g., client devices) where memory and computational resources are limited. This facilitates a distribution of the LLM. More specifically, the LLM architecture of the present disclosure is distributed between one or more client devices and one or more servers such that some operations of the LLM are executed on the client device(s) and some on the server(s). To address the security issues of conventional LLMs, data of certain operations of the LLM of the present disclosure are encrypted. In some aspects, the encryption is performed using partial homomorphic encryption (PHE). In some aspects, data of operations executed on the server are encrypted, whereas data of operations executed on the client device are unencrypted. This assures confidentiality of information without wasting resources on encryption where it is not needed (e.g., on a local client device).

In an exemplary aspect, all matrices of weights are represented in 1-bit format. In 1-bit format, there is no multiplication operation (because of data is binarized (−1,0,1) in INT8 format) and only addition operations and change of sign operations are performed. This makes matrix/vector operations on the matrices computationally faster than floating point matrix multiplication. In some aspects, input/output vector data is still represented in floating point format (FP16 format). Because PHE enables addition operations and does not conflict with 1-bit format, PHE may be used for encrypting certain data. The data associated with vector operations and other matrix operations that require multiplication and division is left unencrypted.

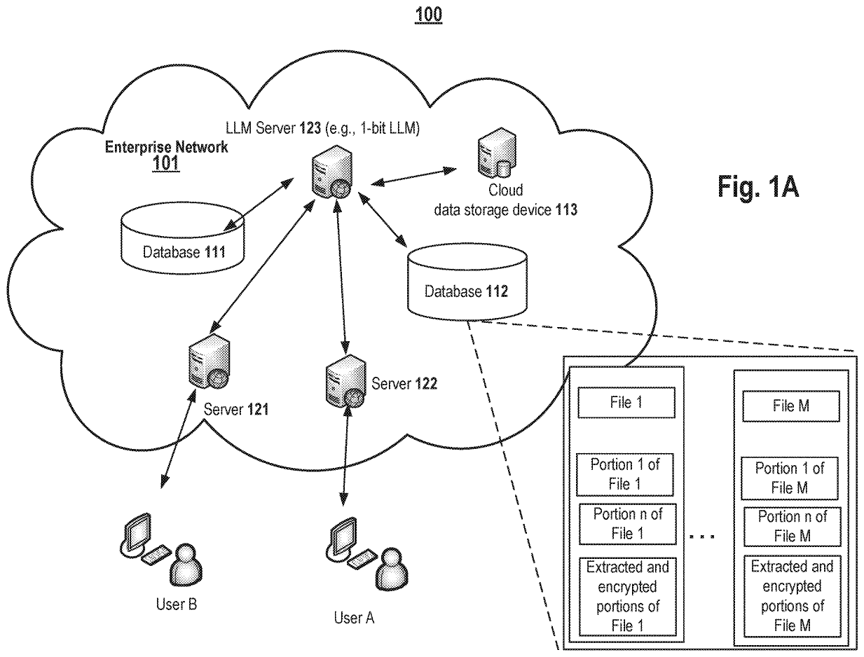

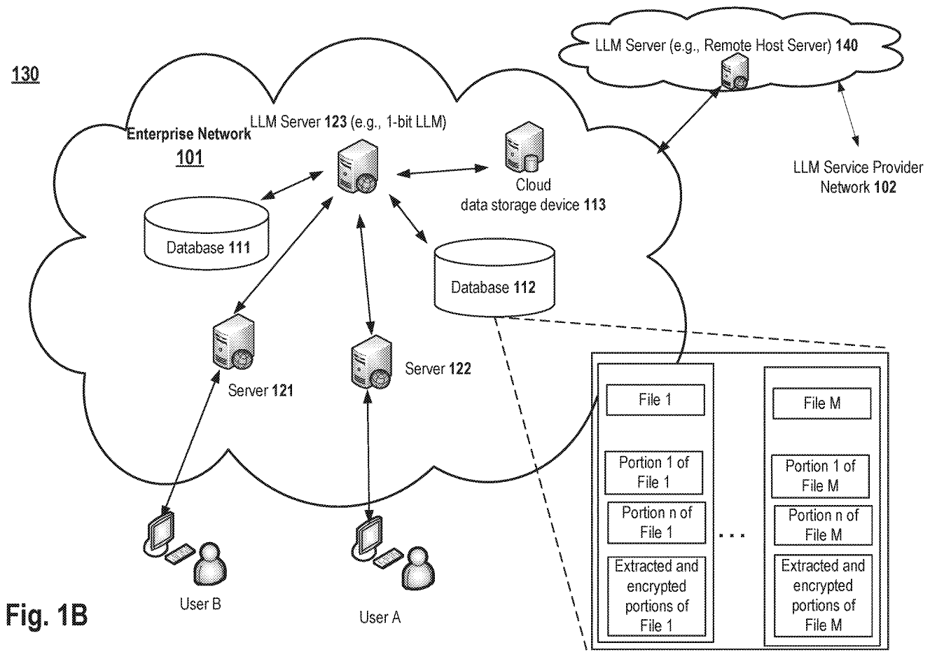

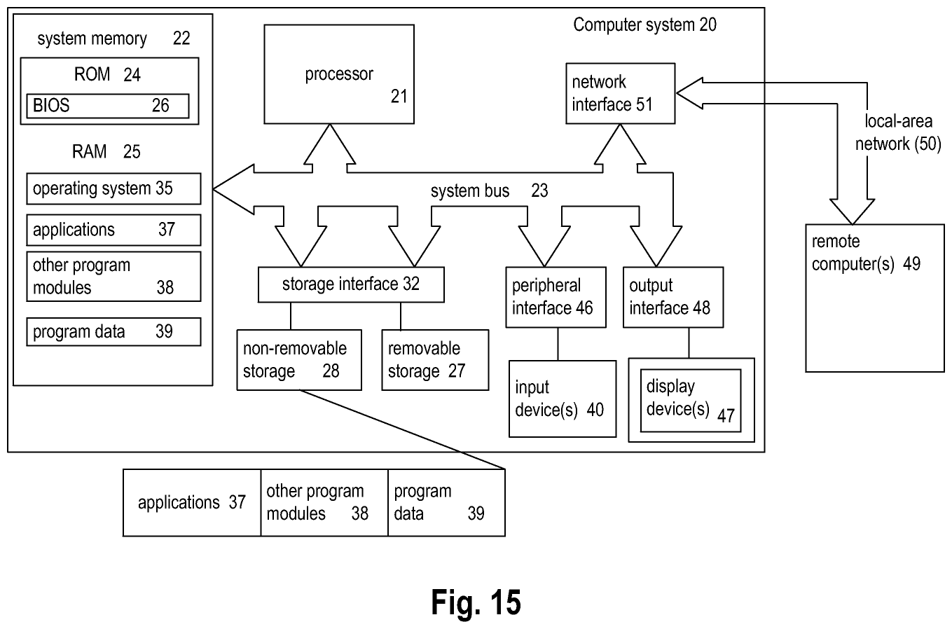

FIG. 1A illustrates a block diagram of an exemplary system 100 for providing a secure local LLM deployment in an enterprise network. In one aspect, the components of system 100 may be implemented on computer systems, such as that shown in FIG. 15.

In one aspect, system 100 includes an enterprise network 101 which includes at least servers 121-123. It is noted that system 100 includes any number of other network components and FIG. 1A only shows the components relevant for the illustrative example of the present disclosure. Users of the enterprise network 101 (e.g., employees or customers) communicate with devices in the enterprise network 101 via one of the servers, e.g., user A communicates with components of the enterprise network 101 via server 122, and user B communicates with components of the enterprise network 101 via server 121. Notably, certain operations of the 1-bit LLM of the present aspect are implemented on LLM server 123.

In addition, enterprise network 101 includes any number of database servers, such as the database servers 111 and 112. In one aspect, data of the enterprise network may also be stored on a cloud storage device, such as the storage device 113 (also referred to as database server 113). Thus, files of the enterprise network may be stored in any of the database servers 111-113. For example, files 1-M, are shown as being stored on the database server 112. In one aspect, the files 1-M may contain any number of portions of data, with some portions being confidential data. Thus, at least some of the portions of the files 1-M may also be encrypted and stored on any of the database servers 111-113.

FIG. 1B illustrates a block diagram of an exemplary system 130 for providing a secure hosted LLM deployment on a remote server 140 for an enterprise. Thus, the system 130 is for the scenario in which the enterprise network accesses LLM functionality from a service provider (e.g., cloud service provider) rather than deploying the functionality on a server of the enterprise.

In one aspect, the system 130 includes an enterprise network 101 which includes at least servers 121-123. The enterprise network 101 is communicatively coupled to an LLM service provider network 102 for accessing LLM functionalities. That is, rather than deploying all of the LLM functionality on the enterprise network 101, the enterprise subscribes to the LLM functionality from a service provider. Users of the enterprise network 101 communicate with devices in the enterprise network 101 via one of the servers, e.g., user A communicates with components of the enterprise network 101 via server 122, and user B communicates with components of the enterprise network 101 via server 121. The LLM of service provider is implemented on the server 140 located in the LLM service provider's network 102.

To enable enterprise employees to use LLM services to intelligently search and query data files and documents stored in the enterprise database, in one exemplary aspect, the LLM server 140 may be configured to operate on the encrypted confidential data of the enterprise network 101. Particularly, in one aspect, the LLM server 140 may be configured to perform LLM training, LLM fine-tuning, and LLM inference (and any other required operations) using the encrypted data without being able to decrypt it, which provides a high-degree of security to the enterprise data. Thus, the 1-bit LLM functionality installed on LLM server 140 has no access to encrypted versions of the confidential data. Moreover, in another example aspect, the user prompts may also be encrypted to allow an even greater degree of confidentiality.

In another aspect where the LLM service provider is a trusted service provider and can have access to unencrypted data, the LLM server 140 accesses data stored in the database servers 111-113, and performs all LLM operations including the encrypting of the content stored on the database servers 111-113. In this scenario, the training, retraining, and fine-tuning of the LLM may be performed by the trusted service provider.

In one of the scenarios, a Large Language Model (LLM) is deployed on the service side in encrypted mode. The user wants to interact with the LLM while keeping the query and answer encrypted. In this case, the query is encrypted using Partially Homomorphic Encryption (PHE) and sent to the service side. The LLM processes this query using addition operations in PHE mode, generates results from these operations, and sends the results back to the user. The user then decrypts the results from the service, performs complex operations on their side, encrypts their results, and sends them again to the service. This back-and-forth exchange allows the service side to manage the bulk of the addition operations, which are the most frequent and thus computationally consuming. Ultimately, the user obtains the final result, while most of the computational load remains on the service side. However, the service does not have access to the query, response, or intermediate results, as they are encrypted and processed in PHE mode. Consequently, the service remains unaware of the details of the query and response.

In one aspect between the service and user, there is a gateway that can transform PHE to standard encryption, allowing the user to decipher using light standard encryption. There is also a gateway that can work in the opposite direction.

For an illustrative non-limiting example, suppose the enterprise network comprises a hospital network with users having access to different portions of data stored in various databases of the hospital. In one aspect, the hospital may obtain LLM services from a trusted service provider. The trusted service provider may then access the data, encrypt the data as needed, set up access lists (if applicable) for various groups of users (e.g., doctors, nurses, administrators, IT personal, etc.), provide decryption keys to users allowed to access certain portions of data, etc. For example, portions of the medical records containing patients'names may be encrypted, but the information about patient's medical condition, treatment protocols and the results of the treatment may remain unencrypted. The LLM may be trained on these partially encrypted filed. When a query is received from a user for an LLM service (e.g., search for information about successful treatment of a particular medical condition), after authenticating the user and checking his access level, the inference module of the LLM server may generate a response to the user prompt. For example, the LLM, which was trained on the patient records, may identify successful treatment cases and summarize conditions of patients and their treatment protocols without revealing patients'names if users access level prohibits access to this information.

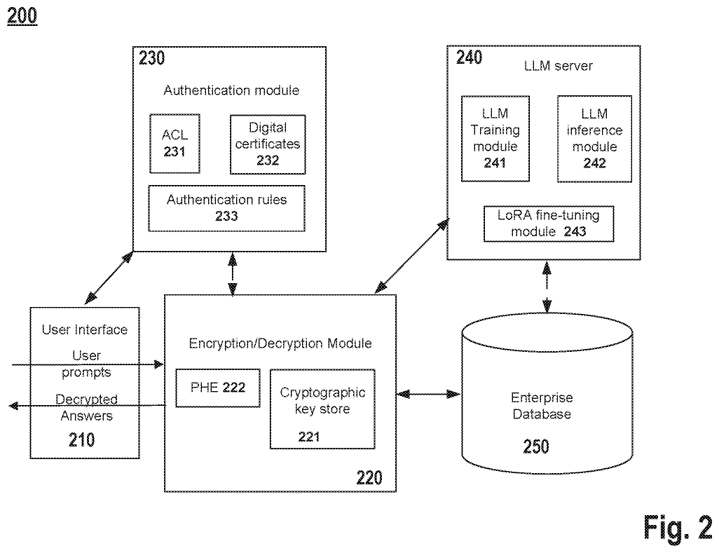

FIG. 2 is an example of a block diagram of functional modules of the system 200 for secure LLM deployment for an enterprise according to one exemplary aspect. Some of these functional modules may be deployed locally on the servers of the enterprise network 101 or hosted on a remote server such as server 140. In one example aspect, the system 200 includes the following functional modules: a user interface 210, an encryption/decryption module 220, an authentication module 230, an LLM server 240, and enterprise databases 250.

In one aspect, the user interface 210 is designed to enable user endpoint devices to access enterprise's LLM functionality in a secure and confidential manner. User interface 210 may be implemented as web-based interface or a desktop application. The user interface 210 allows users to use text prompts to perform text-based searches for documents in enterprise database 250, to query the LLM server 240 for answers to specific questions related to the documents and files stored in the enterprise database 250, or, depending on the natural language processing capabilities of the LLM server 240, to simulate a conversation with the LLM server 240 on topics related to the documents contained in the database 250 or other topics on which the LLM server 240 has been trained to answer. In one aspect, the access to the LLM services and/or to confidential documents in the enterprise database 250 is allowed to authenticated users only and/or users who have an appropriate level of access (e.g., doctors, administrators, IT staff, etc.).

In one aspect, the authentication module 230 is provided to enable authentication of users that access LLM services of the enterprise via the interface 210. In one example, the authentication may be performed using an Access Control List (ACL) 231, identifying individual users and their respective access level to documents in the enterprise database. In another example, the authentication can be performed using cryptographic techniques, such as digital certificates 232 associate with individual users. Yet in another example, various authentication rules 233 may be used to specify the access level of individual users or groups/categories of users, what confidential data is accessible to the users, whether user's LLM prompts should be encrypted, etc. Alternatively, a combination of these and other known authentication techniques may be used.

For example, if a user query does not include the key(s) associated with an authorized user (as indicated in ACL 231), basic unencrypted LLM data and matrices are used. If the keys are provided, depending on the level of access, whole matrices and LLM data with both encrypted and encrypted data may be used. In some aspects, different LLMs are trained, each with a different amount of access to data. For example, a limited LLM may be able to provide simple answers without confidential data. A full LLM may provide more advanced answers for users having access keys.

In order to access LLM services external to the enterprise while maintaining the security of user prompts and confidential enterprise data, the enterprise may encrypt its confidential data using homomorphic encryption that allows LLM server 240 to perform operations on the encrypted data without decryption thereof. In one example, the encryption/decryption module 220 is deployed on a server in the enterprise network 101 and configured to perform encryption/decryption of confidential data using PHE 222. An advantage of using PHE is that it is more efficient than FHE in terms of computational load, particularly for 1-Bit LLM implementations.

Furthermore, since homomorphic encryption used by the module 220 is a form of asymmetric encryption algorithm that uses private/public key pairs for encryption and decryption of data files, module 220 may store all generated cryptographic key pairs in a datastore 221. Furthermore, since module 220 may be also configured to encrypt user prompts, which provides an extra level of security and confidentiality to the enterprise, the cryptographic keys generated for each user to encrypt his/her prompts are also stored in the datastore 221.

PHE is a cryptographic technique that enables specific types of computations on encrypted data while maintaining its confidentiality. Unlike FHE, which allows arbitrary computations on encrypted data, PHE supports only certain operations (e.g., addition, multiplication-but not both simultaneously). Accordingly, when matrix operations involving addition or multiplication are performed by an LLM to generate outputs, the operations remain successful and generate proper results despite the encryption. In another example, suppose that the LLM is trained on a document that states “Mary was born on Jan. 1, 1990.” If the birthdate is encrypted (suppose that the encrypted value generated using an encryption key is 123432), the modified document may state “Mary was born on 123432.” The LLM may be trained using this modified document, which prevents the actual birthdate from being leaked/stolen. The trained LLM may generate an output stating “Mary's birthdate is 123432” to a user query “what is Mary's birthdate?”. Here, the output includes the encrypted value of the birthdate. A user with a decryption key may be able to generate the statement “Mary's birthdate is Jan. 1, 1990” using this key.

In some aspects, the PHE used in the present disclosure may be the Paillier cryptosystem, which supports addition operations on encrypted values. This means that one can perform additions on ciphertexts without decrypting them first. PHE is valuable in scenarios where specific computations need to be performed on sensitive data while it remains encrypted, such as in privacy-preserving computations in the cloud or secure multi-party computations. By allowing limited operations on encrypted data, PHE strikes a balance between data utility and confidentiality, enabling practical applications of secure computation in various domains, including finance, healthcare, and decentralized systems. In some aspects, PHE schemes can be performed with a pair of keys based on, for example, RSA (a public-key cryptosystem). In other aspects, PHE schemes can be performed with a single key based on, for example, the Paillier cryptosystem.

In one example aspect, the system 200 further comprises an LLM server 240 that executes an LLM program. The LLM server 240 may be deployed on a local enterprise server, as shown in FIG. 1A, or on a remote host server, as shown in FIG. 1B. The LLM server 240 includes a LLM training module 242, LLM inference module 242, and LLM fine-tuning module 243. The training module 241 is configured to train LLM on files stored in enterprise database. In one aspect, an LLM may be trained both on the unencrypted files that do not contain any confidential data and encrypted files that contain confidential data. In another aspect, LLM may be pretrained using unencrypted files, and then finetuned by module 243 using encrypted files. Notably, PHE encryption allows LLM training, finetuning, and inference to be performed on the encrypted files. Particularly, matrix-vector mathematical operations can be performed on the encrypted data. This allows enterprise to use LLM services while maintaining the secrecy of the confidential data.

In one aspect, fine-tuning module 243 may implement Low-Rank Adaptation (LoRA) algorithm, which provides high-efficiency LLM optimization. For example, prompts and corresponding responses (e.g., samples from historical data) may be used for fine-tuning the LLM for a specific task. The fine-tuning using the LoRA technique involves differentiating new elements that are not well represented in previous training sets of data and modified elements that are recognized, but not adequately represented in previous training sets of data, and then modifying a small portion of weights of the model for performing the fine-tuning. Thus, the weights of the model affected by the new elements and modified elements are changed to improve the accuracy of the LLM training. In one aspect, the LoRA fine-tuning module 243 of the present disclosure is used to further optimize the performance on the PHE encrypted data. LoRA-related data may be stored separately and be encrypted, e.g., by the PHE algorithm, in the same way as described above.

In terms of training, the LLM may be trained through a process called unsupervised learning on a large dataset comprised of text from across various sources (e.g., webpages, documents, articles, etc.). The training begins by initializing the model with random parameters. The LLM then processes sequences of text, ranging from a few words to entire paragraphs, predicting the next word in each sequence. These predictions are compared to the actual next words in the dataset, and the model adjusts its parameters to minimize the difference between its predictions and the actual text. This process, known as backpropagation, is repeated iteratively over several (millions or possibly billions) text examples, allowing the model to learn intricate patterns, grammar rules, contextual understanding, and semantic relationships. The model's objective during training is to maximize the likelihood of generating the correct next word given a sequence of previous words. Additionally, fine-tuning techniques may be applied to adapt the model to specific tasks or domains, further enhancing its performance and applicability. Through this iterative process, the LLM gradually develops a nuanced understanding of language and can generate coherent and contextually appropriate responses to a wide range of queries.

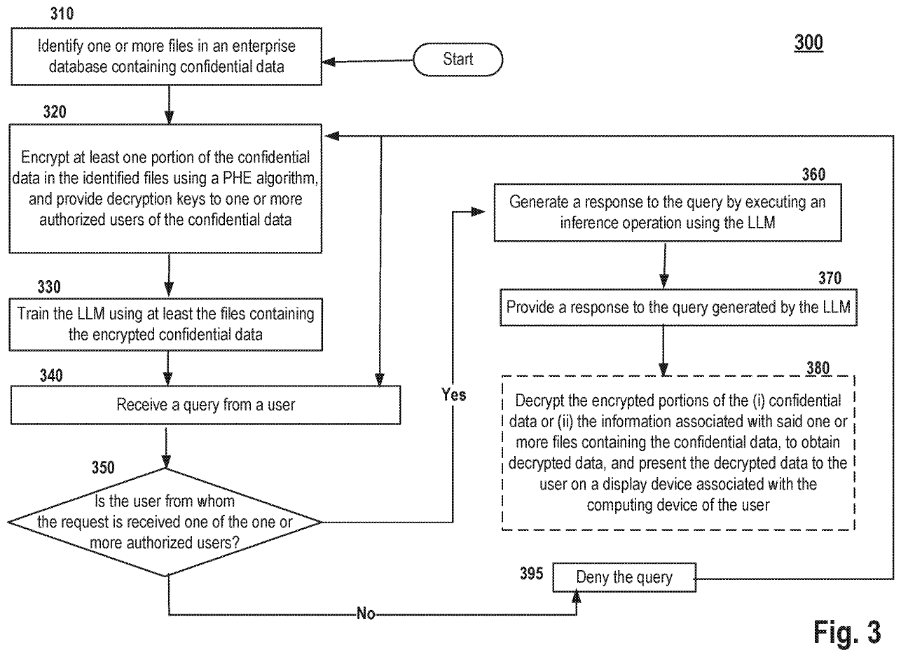

FIG. 3 illustrates a method 300 for providing a secure LLM deployment in an enterprise in accordance with aspects of the present disclosure. In step 310, method 300 identifies one or more files in an enterprise database containing confidential data. The enterprise database is configured to limit access to the confidential data based on an encryption of the confidential data.

In one aspect, the limit to the access to the confidential data is further based on a user's access level. For example, user A may have a different access level from user B. Moreover, based on their respective roles in the enterprise, users A and B may have different needs for accessing different portions of the confidential data. For instance, if the enterprise is a hospital, doctors, nurses, patients, hospital administrators, IT personal etc., would have differing needs for accessing confidential data. Thus, an access control list (ACL) may be used to facilitate compliance to established policies and regulations. The ACL may be implemented on any of the servers of the enterprise. Gateway devices communicating with users may then access the ACL to determine whether access to confidential data is to be granted to a particular user. As mentioned above, a user may be granted access to specific portions of confidential data.

Thus, in one aspect, the determination of whether the user from whom the request is received is one of the one or more authorized users is further based on an ACL of the enterprise.

In step 320, by a server, method 300 encrypts at least one portion of the confidential data in the identified files using a partial homomorphic encryption (PHE) algorithm, and provides decryption keys to one or more authorized users of the confidential data.

In one aspect, the encrypting of the at least one portion of the confidential data further includes: identifying a plurality of matrix-vector operations, performed during the training of the LLM, that are associated with the confidential data; and encrypting the plurality of identified matrix-vector operations using the PHE algorithm, wherein encrypting further includes: encrypting the confidential data stored in the matrix, and encrypting logical operations performed on vector-matrix.

In step 330, by the server, method 300 trains the LLM using at least the files containing the encrypted confidential data. Once the training of the LLM is completed, the LLM server is ready to respond to prompts by performing an inference operation.

In one aspect, the LLM is a 1-bit LLM where an operation of multiplication of matrix to vector is efficiently replaced by changes of sign and addition.

In one aspect, the training of the LLM comprises: taking a LLM partially trained at least on files from enterprise database that do not contain any confidential data; and completing the training using the files containing the encrypted confidential data.

In step 340, by the server, method 300 receives a query from a user, wherein the query comprises a request (i) for searching for the one or more files containing the confidential data or (ii) for obtaining information associated with said one or more files.

In step 350, by the server, method 300 determines whether the user from whom the request is received is one of the one or more authorized users of (i) the one or more files containing the confidential data or (ii) the information associated with said one or more files containing the confidential data. When the user from whom the request is received is one of the one or more authorized users, the method proceeds to step 360. When the user from whom the request is received is not one of the authorized users, the method proceeds to step 395.

In one aspect, the determination of whether the user from whom the request is received is one of the one or more authorized users, includes: identifying one or more files associated with the query received from the user; for each identified file associated with the query received from the user which is among the one or more files containing the confidential data, applying the ACL of the enterprise; and generating the response by executing the inference operation only on the one or more files for which the user's access level is determined as being sufficient.

In step 360, by the server, method 300 generates a response to the query by executing an inference operation using the LLM. For example, the server may prompt an LLM server for a response to the query.

In one aspect, the LLM operation may be implemented on the same server as the server interacting with the user. In another aspect, the server interacting with the user is distinct from the server performing the LLM operations.

In one aspect, the LLM is deployed on a server located in the network of the enterprise. In another aspect, the LLM is deployed on a remote server, which may be a cloud server or a server of a service provider providing LLM functionality to the enterprise.

In step 370, by the server, method 300 provides a response to the query generated by the LLM, wherein, when the response includes the at least one portion of the confidential data that is encrypted, the encrypted portion of the confidential data is decryptable using the decryption key provided to the user of the one or more authorized users.

In one aspect, the generating of the response to the query by executing the inference operation using the LLM comprises: prompting the LLM using encrypted prompts, thereby an LLM hosting platform that performs the inference operation replies to the prompt without decrypting the encrypted at least one portion of confidential data. For example, the prompt from the user is processed by the user interface 210 to generate a vector of features of the prompt. Then, the PHE 222 is used to encrypt the vector and send the resulting encrypted prompt to the LLM server 240. The LLM server 240 operates on the encrypted prompt to generate a response via the LLM inference module 242, and sends the generated response. Then, the response is decrypted by encryption/decryption module 220 and sent to the user interface 210.

In one aspect, the response to the query from the user includes at least encrypted portions of (i) confidential data or (ii) information associated with said one or more files containing the confidential data.

In one aspect, once the computing device of the user receives the response from the server, the computing device of the user decrypts the encrypted portions of the (i) confidential data or (ii) the information associated with said one or more files containing the confidential data, to obtain decrypted data. Then, the computing device of the user presents the decrypted data to the user on a display device associated with the computing device of the user.

Thus, in optional step 380, by the computing device of the user, method 300 decrypts the encrypted portions of the (i) confidential data or (ii) the information associated with said one or more files containing the confidential data, to obtain decrypted data; and presents the decrypted data to the user on a display device associated with the computing device of the user. The method then proceeds to step 320 and/or 340 to continue encrypting newly received confidential data and/or receive queries from users.

In step 395, by the server, method 300 provides a response to the query denying the request. The method then proceeds to step 320 and/or 340 to continue encrypting newly received confidential data and/or receive queries from users.

In one aspect, operations of the enterprise other than the operations provided using the secure LLM are performed on unencrypted data.

In one aspect, operations of the enterprise other than the operations provided using the secure LLM are performed on data encrypted using a Fully Homomorphic Encryption (FHE) algorithm.

In one aspect, the method further comprises: executing steps without decrypting the at least one portion of the confidential data that is encrypted, at least for one of: inference operations, training of algorithms, retraining of algorithms, data preparation and specialization of the algorithm for a specific application.

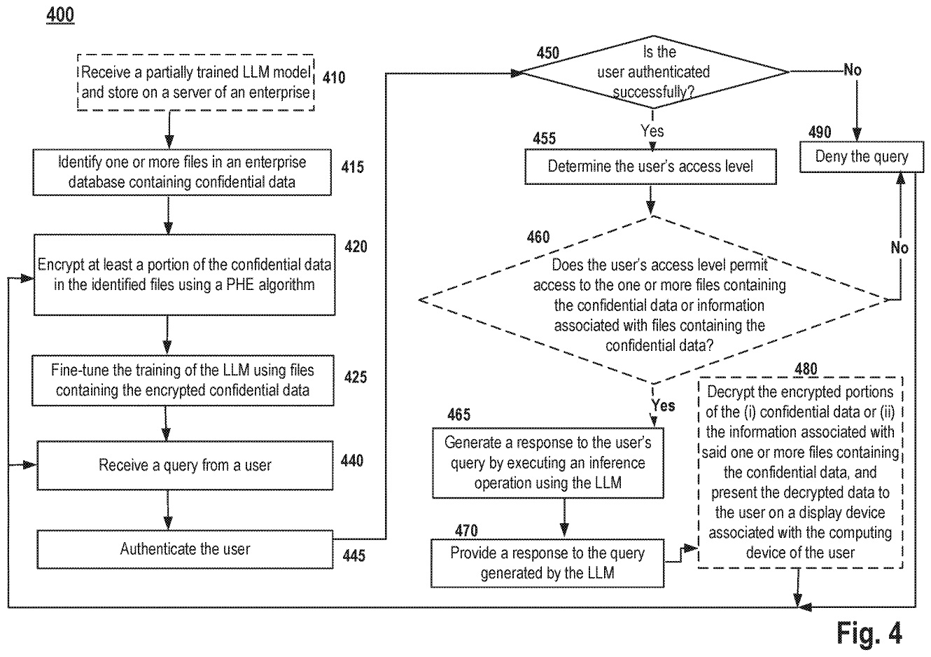

As described above, during execution of the steps of method 300, the enterprise database is configured to limit access to the confidential data based on an encryption of the confidential data. However, the ACL was an optional feature. The usage of the ACL when it is not optional is further described below in conjunction with FIG. 4. Method 300 mainly uses encryption techniques for data security by providing the decrypting keys only to authorized users. Thus, users of the enterprise network may be provided different decryption keys for accessing different portions of confidential data. Alternatively, a method for providing the secure LLM may use both the encryption and the ACL in an integrated manner.

FIG. 4 illustrates an example of a method 400 for providing a secure LLM deployment in an enterprise using encryption and Access Control List (ACL) in accordance with aspects of the present disclosure.

In optional step 410, method 400 receives a partially trained LLM algorithm and stores the partially trained LLM on a server, e.g., a server of the enterprise.

In step 415, method 400 identifies one or more files in an enterprise database containing confidential data. The enterprise database is configured to limit access to the confidential data based on an encryption of the confidential data and usage of ACL.

In step 420, by a server, method 400 encrypts at least one portion of the confidential data in the identified files using a PHE algorithm, and provides decryption keys to one or more authorized users of the confidential data.

In step 425, by a server, method 400 fine-tunes the trained LLM using files containing the encrypted confidential data.

In step 440, by the server, method 400 receives a query from a user, wherein the query comprises a request (i) for searching for the one or more files containing the confidential data or (ii) for obtaining information associated with said one or more files.

In step 445, by the server, method 400 authenticates the user.

In step 450, by the server, method 400 determines whether the user is authenticated successfully. When the user is authenticated successfully, method 400 proceeds to step 455. Otherwise, the method proceeds to step 490.

In step 455, by the server, method 400 determines the access level of the user from whom the query is received.

In step 460, by the server, method 400 determines whether the access level of the user permits access to the one or more files containing the confidential data or (ii) the information associated with said one or more files containing the confidential data. When the access level of the user permits access to the confidential data or (ii) information associated with said one or more files, method 400 proceeds to step 465. When the access level of the user does not permit access to the confidential data or (ii) for obtaining information associated with said one or more files, method 400 proceeds to step 490.

In step 465, by the server, method 400 generates a response to the query by executing an inference operation using the LLM.

In step 470, by the server, method 400 provides a response to the query generated by the LLM, wherein, when the response includes the at least one portion of the confidential data that is encrypted, the encrypted portion of the confidential data is decryptable using the decryption key provided to the user of the one or more authorized users.

In optional step 480, by the computing device of the user, method 400 decrypts the encrypted portions of the (i) confidential data or (ii) the information associated with said one or more files containing the confidential data, to obtain decrypted data; and presents the decrypted data to the user on a display device associated with the computing device of the user.

In step 490, method 400 denies the query. The method may then proceed to step 440 to receive more queries, or to step 420 to receive more data for encryption.

In one aspect, the LLM is a 1-bit LLM where an operation of multiplication of matrix to vector is efficiently replaced by changes of sign and addition.

In one aspect, the LLM is deployed on a local enterprise server.

In one aspect, the LLM is deployed on a remote host server.

In one aspect, encrypting at least the confidential data further includes: identifying a plurality of matrix-vector operations, performed during the training of the LLM, that are associated with the confidential data; and encrypting the plurality of identified matrix-vector operations using the PHE algorithm, wherein encrypting further includes: encrypting the confidential data stored in the matrix, and encrypting logical operations performed on vector-matrix.

In one aspect, the response to the user's query includes at least encrypted portions of (i) confidential data or (ii) information associated with said one or more files containing the confidential data.

In one aspect, the determination of whether the user's access level permits access to (i) the one or more files containing the confidential data or (ii) the information associated with said one or more files containing the confidential data, includes: identifying one or more files associated with the user's query; for each identified file associated with the user's query which is among the one or more files containing the confidential data, applying the ACL of the enterprise; and generating the response to the user's query by executing the inference operation only on the one or more files for which the user's access level is determined as being sufficient.

In one aspect, operations of the enterprise other than the operations provided using the secure LLM are performed on unencrypted data.

In one aspect, operations of the enterprise other than the operations provided using the secure LLM are performed on data encrypted using a Fully Homomorphic Encryption (FHE) algorithm.

In one aspect, the method further comprises executing steps without decrypting the at least one portion of the confidential data that is encrypted, at least for one of: inference operations, training of algorithms, retraining of algorithms, data preparation and specialization of the algorithm for a specific application.

In one aspect, the generating of the response to the query by executing the inference operation using the LLM comprises: prompting the LLM using encrypted prompts, thereby an LLM hosting platform that performs the inference operation replies to the prompt without decrypting the encrypted at least one portion of confidential data.

Integrating PHE into training a LLM involves encrypting the sensitive data involved in the training process, such as the training data itself, gradients, or model parameters.

In one aspects, training data is encrypted using PHE before being sent to the training server. This ensures that the data remains confidential throughout the training process. Techniques like additive or multiplicative homomorphic encryption can be used based on the specific operations required during training.

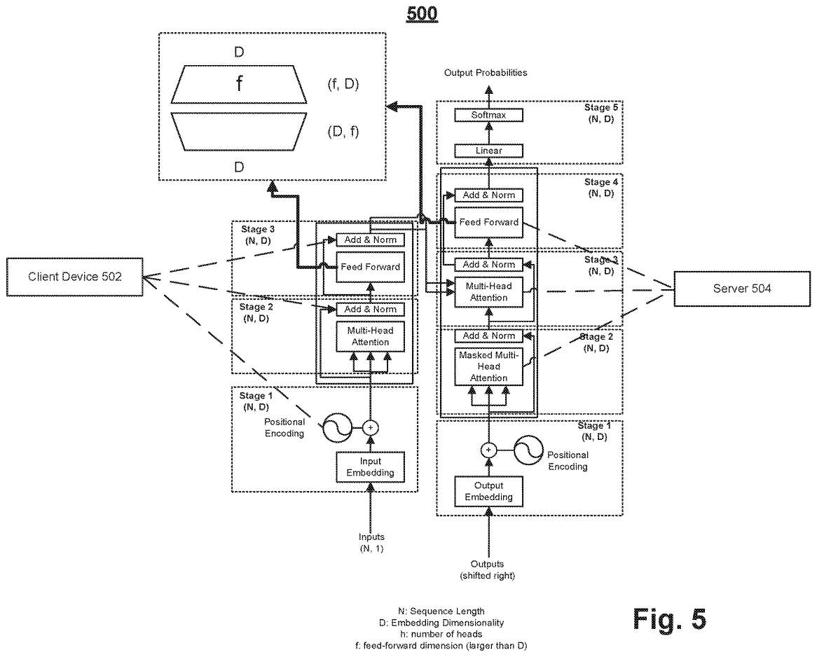

FIG. 5 is a block diagram of an encoder and decoder-based architecture 500 on which layer-specific encryption is performed. Architecture 500 significantly reduces memory footprint and energy consumption and can be effectively scaled to even larger language models with potential benefits in terms of performance and efficiency. Here, D represents embedding dimensionality and is a small vector, h is a number of heads and is also a small number, and f is a feed-forward dimension, which is a large matrix (implement feed-forward using 1-bit format). The system performs training on encrypted data and to generate 1-bit encrypted matrices.

An encoder is used to analyze user queries and a decoder is used to generate answers to the queries. The encoder may be stacked Nx layers high (multiple encoder layers) and likewise the decoder may be stacked Nx layers high. These layers are distributed over client device 502 (e.g., server 121) and server 504 (e.g., LLM server 140).

In architecture 500, all large weight matrices are in 1-bit format and therefore operations with those matrixes (e.g., linear, feed forward, matmul operations) are encrypted using PHE, and sent from client device 502 in secrecy for training or inference to server 504 hosting other layers of the architecture 500. In some aspects, vectors including embeddings or training data may be encrypted using PHE. Furthermore, operations on matrixes and vectors may be encrypted in PHE.

Architecture 500 is marked showing dimensionality of each stage. A typical transformer architecture includes stacks of attention and feed forward layers. In some aspects, there may be 12 layers.

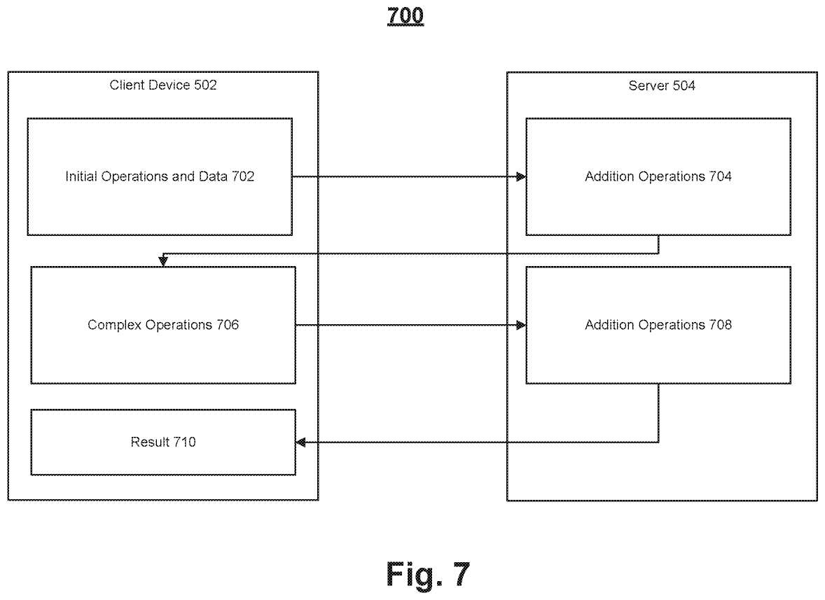

Linear, feed forward, matmul operations involve matrix-vector multiplication and addition and can be performed in 1-bit format. All other operations, which involve not only multiplication/additions, but other operations, such as normalization operation (e.g., Layernorm) which transforms all numbers in vectors to 0-1 range and involves division operation, and Scaled Dot-Product Attention (shown in FIG. 7), which also involves division and square root operation, cannot be performed in 1-bit format and cannot be PHE encoded. These, operations can be encrypted using other techniques or performed on the client device 502.

For example, in the architecture 500, the positional encoding block involves sin and cosine functions and division and therefore cannot be PHE encoded. Such encoding may be performed on the client device 502.

In another example, the vector input into a feed forward block at stage 3 may be PHE-encrypted by client device 502 and sent to server 504. All weight matrixes stored on the server 504 involving a feed forward operation may be in 1-bit format and PHE encrypted. The server 504 will perform the feed forward operation on the PHE-encrypted vector and PHE-encrypted matrixes, and return a PHE-encrypted result to the client device 502. The client device 502 will decrypt the received data and perform the Add&Norm operation of Stage 3. Then, the client device 502 may encrypt results using PHE and send it back to the server 504 to perform Multi-Head Attention at stage 3 (right-hand column of architecture 500). Masked Multi-Head attention is also performed using 1-bit architecture (where all weights are in 1-bit format).

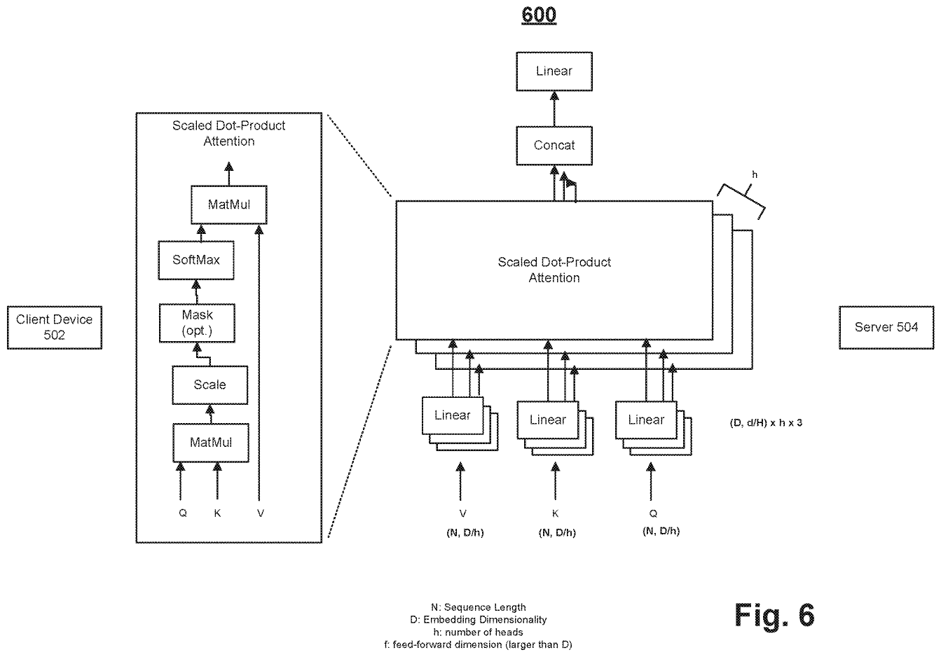

FIG. 6 is a block diagram of a multi-head attention block 600. In some aspects, Multi-Head Attention, which involves a linear operation followed by Scaled Dot-Product Attention, may also be split between the client device 502 and server 504. Linear operations can be performed on PHE encrypted 1-bit matrices, and Scaled Dot-Product Attention, which involves division and square root operation, can be performed on the client device 502 or in FHE encrypted from on the server 504. In fact, the Attention operation has low dimensionality and therefore is not computationally intensive and can be easily performed by the client device 502 in unencrypted form.

The scale block involves division and a square root function and is therefore not compatible with PHE. Softmax involves exponents and division. The Mask block is simply matrix addition and can be 1-bit and PHE encrypted performed on the server. MatMul is matrix multiplication, which can be in 1-bit format, PHE encoded and performed on the server 504.

Compared with regular transformers or other 1-bit LLMs such as BitNet, architecture 500 keeps components high-precision, e.g., 8-bit. In other words, in the BitNet system, 1-bit transformers are trained from scratch (not converted). However, in the present disclosure input and output vectors are still in floating point format (FP16). This is for multiple reasons. First, the residual connections and the layer normalization contribute negligible computation costs to LLMs. Second, the computational cost of QKV transformation is much smaller than the parametric projection as the model grows larger. Third, the precision is preserved for the input/output embedding because the language models have to use high-precision probabilities to perform sampling.

In some aspects, only linear layers are quantized (i.e., in 1-bit format). The quantization is performed per tensor during training while per token during inference for both stability and efficiency.

FIG. 7 is a block diagram 700 of a generalized example for performing LLM operations using a client device and a service provider. In diagram 700, initial operations and data 702, addition operations 704, complex operations 706, and addition operations 708 are all part of an LLM. For example, the operations may be performed in different layers of the LLM.

Initial operations and data 702 are performed on client device 502. Because addition operations 704 is compatible with PHE, client device 502 may encrypt the input of operations 704 using PHE and transmit them to server 504. The results of operations 704 are returned to client device 502, which may then decrypt the result and perform complex operations 706 that are incompatible with PHE. Because addition operations 708 are compatible with PHE, the results of operations 706 may be encrypted using PHE and transmitted to server 504. Server 504 ultimately transmits result 710 to client device 502, which decrypts the result for presentation to a user.

In some aspects, the first operation comprises computing a square root of a number via series expansion using addition and multiplication operations. In general-case square root calculation for scaled dot-product attention in low-precision transformer inference, a series-based realization can be employed without reliance on full-precision computation throughout the pipeline. A method is provided to apply a scaling factor s=1/√(d_k) while retaining binarized weight and activation paths for the heavy tensor operations. The method comprises precomputing the per-head scale s outside the 1-bit path using multi-bit accumulators, with d_k known and constant per head, by computing s once during initialization or offline via a low-degree polynomial approximation evaluated using Horner's method, a lookup from precomputed values, or a power-of-two approximation with m such that s≈2\hat{ }m; the selected s is stored per head as a small higher-precision constant (e.g., FP16 or fixed-point int16). During attention computation, binary projections are performed such that Q=sign(X W_Q), K=sign(X W_K), and V=sign(X W_V), producing 1-bit activations and enabling binary multiplications in the projection path. Query-key dot products are computed using an XNOR plus popcount kernel (alternatively sign multiplication plus sum), with the resultant popcount or sum accumulated in a multi-bit accumulator (e.g., int16 or int32). The stored scale s is then applied to the multi-bit dot-product accumulator by multiplication in higher precision or, where s is a power of two approximation, by bit-shift on the accumulator. Softmax is executed in higher precision, with FP16 or INT32 logits and exponentiation/summation, and value mixing optionally maintained in low or mixed precision while using accumulators for weighted sums. The method confines non-1-bit arithmetic to precomputation of s, per-logit scaling, and softmax reductions, while preserving 1-bit efficiency for weight and activation storage, binary matrix multiplications in Q/K/V projections, and the XNOR/popcount inner-product kernels. By decoupling square root computation from inference via series expansion or lookup evaluated once per head and by applying the resulting constant scale within the accumulator path, the approach eliminates runtime square root evaluation, maintains binarized throughput for core tensor operations, and achieves accurate scaling of attention logits with minimal precision overhead.

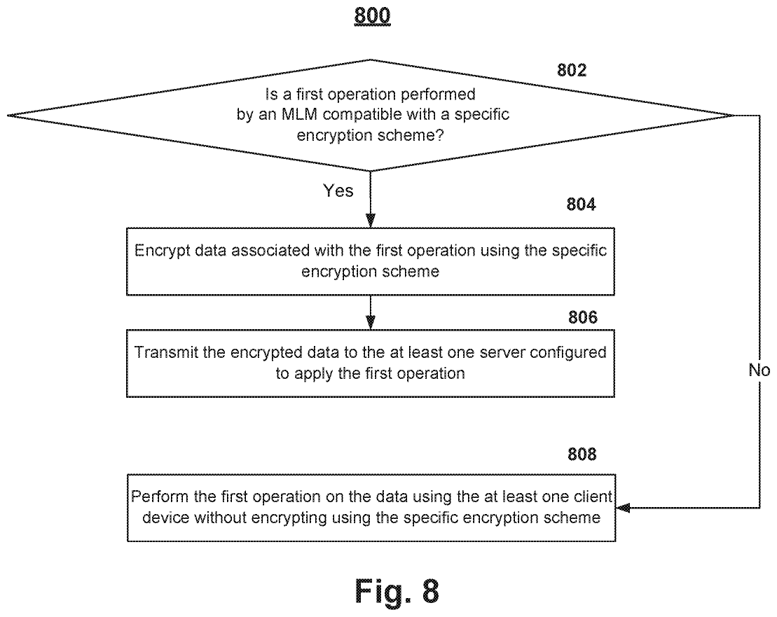

FIG. 8 illustrates method 800 for securely executing an MLM. At 802, module 220 determines whether a first operation performed by an MLM is compatible with a specific encryption scheme. In some aspects, the specific encryption scheme is PHE and the MLM is a 1-bit LLM. It should be noted that in method 800, the MLM is distributed over at least one client device (e.g., client device 502 that is in enterprise network 101) and at least one server (e.g., server 504 that is part of LLM service provider network 102).

Determining the compatibility of a first operation with PHE involves assessing whether the operation can be simplified or transformed into addition operations. This is because PHE schemes typically support a limited set of operations, such as addition, on encrypted data without requiring decryption. For instance, consider matrix multiplication, a common operation in data processing. Matrix multiplication involves a series of multiplications and additions. However, it can be decomposed into a series of addition operations by breaking down the multiplication into repeated addition, which aligns with the capabilities of PHE. Similarly, if the first operation is a linear operation, such as a linear transformation or a linear combination of variables, module 220 can convert this operation into a series of addition operations.

Accordingly, in some aspects, determining whether the first operation is compatible with the specific encryption scheme involves determining whether the first operation can be reduced to one or more addition operations (which are compatible with PHE). Suppose the first operation comprises a linear operation; module 220 may convert the linear operation into one or more addition operations.

In response to determining that the first operation is compatible with the specific encryption scheme, method 800 advances to 804, where module 220 encrypts data associated with the first operation using the specific encryption scheme. At 806, module 220 transmits the encrypted data to the at least one server configured to apply the first operation. For example, addition operations 704 are compatible with PHE, and accordingly the data that serves as an input to addition operations 704 may be encrypted by client device 502 and sent to server 504.

In response to determining, at 802, that the first operation is incompatible with the specific encryption scheme, method 800 advances to 808, where LLM inference module 242 performs the first operation on the data using the at least one client device without encrypting using the specific encryption scheme. In this case, the operation is performed locally. For example, in FIG. 7, initial operations and data 702 may be incompatible with PHE and are performed on client device 502.

In some aspects, the data is input data provided by a user. Accordingly, the at least one client device (e.g., client device 502) may receive a result of the first operation (e.g., operations 704) from the at least one server (e.g., server 504). Client device 502 may then determine a decrypted value from the result using a decryption key (in datastore 221) associated with the specific encryption scheme.

In some aspects, if that is the final result, user interface 210 may output the decrypted value on the at least one client device.

In some aspects, module 220 may also determine whether a second operation (e.g., complex operations 706) performed by the MLM is compatible with the specific encryption scheme. In response to determining that the second operation is incompatible with the specific encryption scheme, LLM inference module 242 may perform the second operation on the decrypted value using the at least one client device without encrypting using the specific encryption scheme.

Suppose that second operation is also a compatible with the specific encryption scheme. In this case, rather than decrypting the first result and performing encryption again, the second operation may also be performed on a result of the first operation applied to the encrypted data.

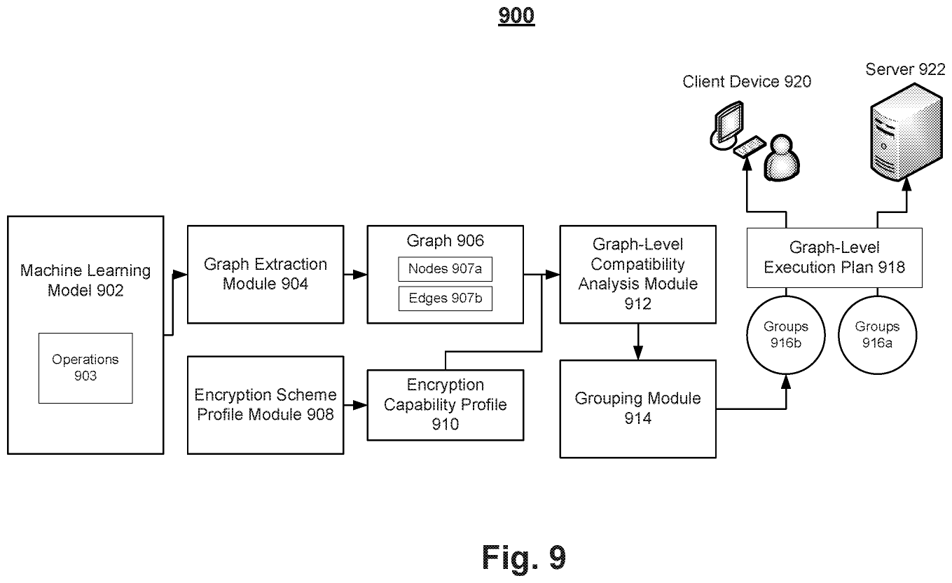

FIG. 9 is a block diagram 900 depicting an operations graph extraction and encryption scheme profiling pipeline for a MLM, including graph-level compatibility analysis and operation group partitioning.

In addition to the features discussed thus far, the disclosed techniques further provide a graph-level optimization framework for secure execution of MLMs, including 1-bit LLMs, under encryption schemes with restricted arithmetic capabilities. In some aspects, the system avoids resolving encryption compatibility on a per-operation basis at run time. The system instead statically or semi-statically analyzes a computational graph representing operations performed by the MLM against declared capabilities of a selected encryption scheme.

Based on the analysis, the system partitions the computational graph into operation groups. First operation groups are made exclusively up of operations that are compatible with the encryption scheme (for example, operations realizable with homomorphic addition and permissible plaintext-ciphertext interactions). Second operation groups include at least one operation that is incompatible with the encryption scheme. The system then generates an execution plan that assigns first operation groups to a remote server for execution over encrypted data and assigns second operation groups to a local client device for execution over plaintext data. The execution plan minimizes unnecessary transitions between encrypted and plaintext domains.

In certain aspects, the analysis phase further identifies parameter-only subgraphs. Outputs of the parameter-only subgraphs depend solely on model parameters and do not depend on user-specific inputs. The system precomputes outputs of the parameter-only subgraphs once and stores the precomputed results. The system reuses the precomputed results across multiple inferences, independent of input instances. As an optional optimization, the client maintains a cache of group-level results keyed to a representation of the input state for each operation group.

When a selected operation group receives the same or an equivalent input state in a subsequent inference, the client retrieves a cached encrypted or decrypted result. The client then bypasses re-execution of the operation group. By performing graph-level partitioning, precomputing parameter-only subgraphs, and caching group-level results, the disclosed techniques reduce the number of encryption/decryption boundaries, lower network round-trip counts, and decrease the volume of homomorphic operations. The disclosed techniques maintain confidentiality of user data in the client-server setting.

Referring to FIG. 9, in some aspects, an operations graph extraction module 904 receives a trained MLM 902, such as a transformer-based 1-bit large language model (LLM), and determines a computational graph 906 of MLM operations that describes the sequence and data dependencies of operations 903 performed when the MLM 902 processes an input.

In some aspects, the MLM 902 may be trained on a corpus of text data, such as a dataset comprising web-crawled documents, books, or domain-specific records, using a self-supervised training objective in which the MLM 902 learns to predict masked or next tokens in a sequence. During training, a training pipeline quantizes model weights to a reduced bit-width representation, such as a 1-bit or ternary weight representation in which each weight assumes a value from a constrained set (e.g., {−1, 0, +1}), thereby reducing memory footprint and enabling the use of integer or bitwise arithmetic during inference. The use of quantized weight representations improves the functioning of the computer system itself by reducing the memory bandwidth and storage requirements of the MLM 902, enabling deployment on resource-constrained client devices 920 that would otherwise lack sufficient memory to store full-precision model parameters, and by replacing floating-point arithmetic operations with more efficient integer or bitwise operations that consume fewer processor cycles and less energy per inference.

The trained MLM 902 may comprise a plurality of transformer layers, each transformer layer including a multi-head self-attention sub-layer and a feed-forward sub-layer, with residual connections and normalization operations interleaved between sub-layers. The computational graph 906 comprises operation nodes 907a representing discrete computational functions performed by the MLM 902, such as linear transformations, activations, normalization, and attention blocks. The computational graph 906 further comprises edges 907b representing data dependencies between operation nodes 907a, thereby encoding the dataflow through which intermediate values propagate during inference. The extraction of the computational graph 906 improves the functioning of the computer system by transforming an otherwise opaque trained model into a structured, machine-analyzable representation that enables automated downstream optimizations, such as compatibility analysis and operation group partitioning, that would not be feasible through manual inspection of the MLM 902.

An encryption scheme profile module 908 receives an encryption scheme, such as a partial homomorphic encryption (PHE) scheme, that defines a set of homomorphically supported operations. The PHE scheme may comprise, for example, a Paillier encryption scheme that supports additive homomorphism, wherein the product of two ciphertexts decrypts to the sum of the corresponding plaintexts, or an ElGamal encryption scheme that supports multiplicative homomorphism. In some aspects, a fully homomorphic encryption (FHE) scheme or a somewhat homomorphic encryption (SHE) scheme may be used in place of the PHE scheme, with the encryption capability profile 910 adjusted accordingly to reflect the broader or narrower set of supported operations. The encryption scheme profile module 908 defines an encryption capability profile 910 for the encryption scheme.

The encryption capability profile 910 specifies which arithmetic operations on plaintext values, such as addition, have corresponding homomorphic operations on ciphertexts and which operations, such as division, exponentials, Softmax, and LayerNorm, are not supported homomorphically. The operations graph extraction module 904 and the encryption scheme profile module 908 may thus produce the computational graph 906 of operations performed by the MLM 902 and the encryption capability profile 910 for the chosen encryption scheme, respectively. The generation of the encryption capability profile 910 improves the functioning of the computer system by providing a machine-readable specification that enables automated, scheme-aware partitioning of the computational graph 906, thereby eliminating the need for manual, error-prone identification of which MLM operations can be performed under encryption and reducing the engineering effort required to adapt the MLM 902 to different encryption schemes.

A graph-level compatibility analysis module 912 receives the computational graph 906 of MLM operations and the encryption capability profile 910. For each operation node 907a in the computational graph 906, the graph-level compatibility analysis module 912 determines whether the operation is compatible with the encryption scheme by checking at least one of: (i) whether the operation is directly supported by homomorphic operations of the encryption scheme, or (ii) whether the operation can be expressed as a composition of primitive operations supported homomorphically by the encryption scheme.

By way of example, the graph-level compatibility analysis module 912 may determine that a linear transformation operation, which computes a weighted sum of inputs using learned weight values, is encryption-compatible because the weighted sum can be expressed as a sequence of homomorphic multiplications of ciphertexts by plaintext weights followed by homomorphic additions of the resulting ciphertexts.

Conversely, the graph-level compatibility analysis module 912 may determine that a Softmax operation, which computes an exponential function over input values followed by a normalization division, is encryption-incompatible because neither the exponential function nor the division operation has a corresponding homomorphic operation in the encryption scheme.

The graph-level compatibility analysis module 912 labels each operation node 907a as encryption-compatible or encryption-incompatible based on this determination. The per-node compatibility labeling improves the functioning of the computer system by enabling a granular, operation-level assignment of computational work between the server 922 and the client device 920, rather than requiring the entire MLM 902 to be executed either entirely under encryption or entirely in plaintext, thereby reducing the volume of homomorphic computation performed on the server 922 and the volume of decryption and re-encryption operations performed on the client device 920.

A grouping module 914 traverses the computational graph 906 along dataflow, for example in a topological order that respects the directed edges 907b, and partitions the computational graph 906 into a plurality of operation groups, including for example first operation groups 916a and second operation groups 916b, each group being a sequence of operation nodes 907a along at least one dataflow path. The first operation groups 916a comprise operation nodes 907a in which every operation node of the group is labeled encryption-compatible. The second operation groups 916b comprise operation nodes 907a in which at least one operation node of the group is labeled encryption-incompatible. In some aspects, the grouping module 914 forms each of first operation groups 916a as a maximal contiguous sequence of encryption-compatible operation nodes 907a such that extending the sequence with an adjacent node would introduce an encryption-incompatible operation.

Forming maximal contiguous groups improves the functioning of the computer system by minimizing the number of transitions between encrypted execution on the server 922 and plaintext execution on the client device 920, where each such transition incurs computational overhead from encryption and decryption operations and communication overhead from transmitting ciphertexts over a network, thereby reducing overall inference latency and network bandwidth consumption relative to approaches that employ finer-grained or non-optimized partitioning of operations.

For each operation group, the grouping module 914 records the group type (first or second), the constituent operation nodes 907a, and group boundaries, including which intermediate values serve as inputs to the group and outputs of the group. The grouping module 914 thereby produces an annotated computational graph of MLM operations with compatibility labels, a set of first and second operation groups with defined boundaries, and a graph-level execution plan 918 that assigns first operation groups 916a to encrypted execution on a server 922 and second operation groups 916b to plaintext execution on a client device 920. The graph-level execution plan 918 improves the functioning of the distributed computer system by offloading computationally intensive, encryption-compatible operations to the server 922 while retaining encryption-incompatible operations on the client device 920, thereby leveraging the greater computational resources of the server 922 for the bulk of the inference workload without exposing user-specific data in plaintext to the server 922.

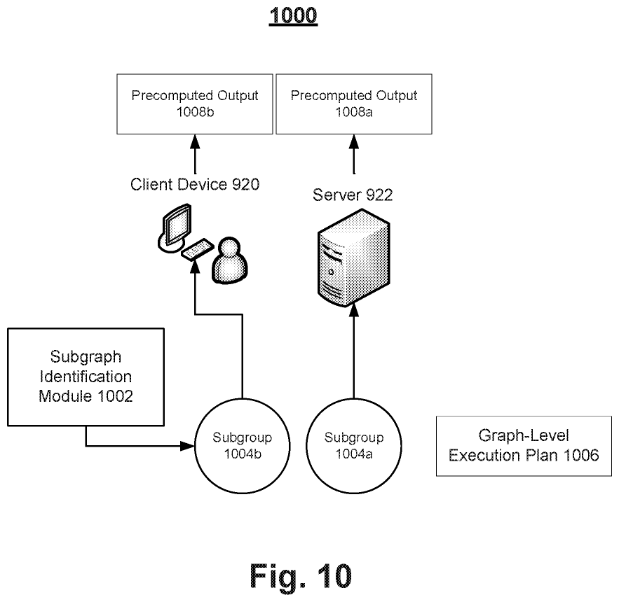

FIG. 10 is a block diagram 1000 depicting identification and precomputation of parameter-only subgraphs within the computational graph 906 of MLM operations.

Referring to FIG. 10, in some aspects, a subgraph identification module 1002 analyzes the computational graph 906 of MLM operations, using the operation groups 916a, 916b and the annotated computational graph 906 produced as described with reference to FIG. 9, to identify subgraphs 1004a, 1004b whose outputs depend only on model parameters or constants and do not depend on user-specific input values.

The subgraph identification module 1002 may perform this identification by tracing the data dependencies of each operation node 907a backward through the computational graph 906 and determining whether every leaf node in the traced dependency path corresponds to a model parameter or a constant rather than a user-specific input value. By way of example, a parameter-only subgraph 1004a may correspond to a bias addition operation whose inputs are a learned bias vector and a weight matrix product that itself depends exclusively on model weights, and a parameter-only subgraph 1004b may correspond to a pre-normalization scaling computation that multiplies a set of fixed scaling constants by a learned gain parameter.

The identification of parameter-only subgraphs improves the functioning of the computer system by isolating portions of the computational graph 906 whose results are deterministic across all user inputs, thereby enabling the system to eliminate redundant computation that would otherwise consume processor cycles and, in the case of subgraphs within first operation groups 916a, eliminating unnecessary homomorphic operations on the server 922 that are substantially more computationally expensive than their plaintext counterparts.

For each identified parameter-only subgraph, the subgraph identification module 1002 determines whether the subgraph lies entirely within first operation groups 916a, entirely within second operation groups 916b, or spans multiple operation groups, and designates the subgraph as precomputable.

The subgraph identification module 1002 precomputes the outputs 1008a, 1008b of the parameter-only subgraphs 1004a, 1004b once, on the server 922 or the client device 920 as appropriate, and stores those precomputed outputs 1008a, 1008b in a memory, such as a local storage or a persistent key-value store accessible to the server 922 or the client device 920.

The subgraph identification module 1002 updates the execution plan to produce an updated execution plan 1006 so that, during runtime execution, the precomputed outputs 1008a, 1008b are retrieved from memory instead of being recomputed. The subgraph identification module 1002 thereby produces a list of parameter-only subgraphs 1004a, 1004b of MLM operations and their precomputed outputs 1008a, 1008b, along with the updated execution plan 1006 that incorporates reuse of precomputed values.

The precomputation and caching of parameter-only subgraph outputs improves the functioning of the computer system by converting repeated runtime computation into a single offline computation followed by memory lookups, thereby reducing runtime inference latency, lowering processor utilization on both the server 922 and the client device 920, and decreasing the volume of data transmitted between the client device 920 and the server 922 during each inference request.

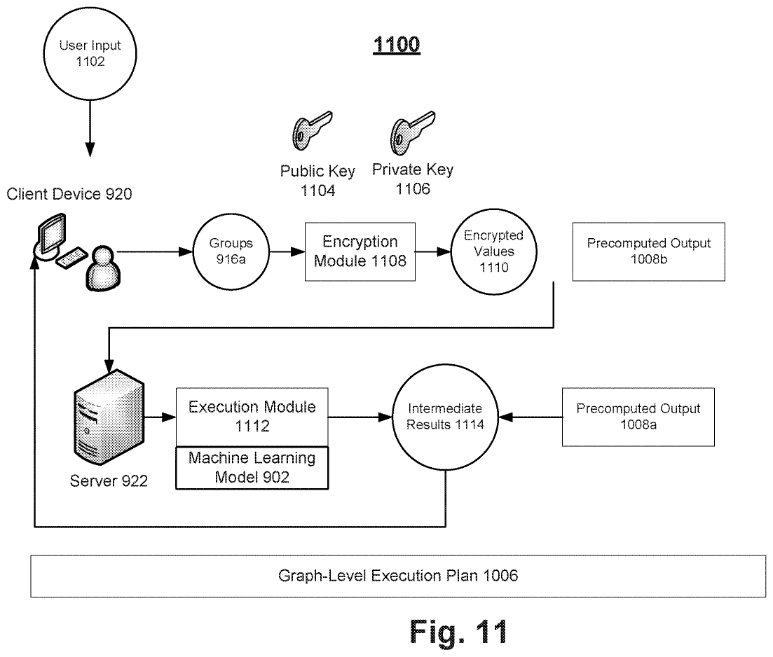

FIG. 11 is a block diagram 1100 depicting runtime execution of first operation groups in a distributed encrypted form using the updated execution plan.

Referring to FIG. 11, in some aspects, the client device 920 receives a user-specific plaintext input 1102 to the MLM 902 via a user interface, such as a graphical text input field, a voice-to-text interface, or an application programming interface (API) endpoint exposed by a client application executing on the client device 920. The user-specific plaintext input 1102 may comprise, for example, a natural language query, a sequence of token identifiers, or an embedding vector representing an input prompt.

The client device 920 initializes starting values for the MLM 902 based on the user-specific plaintext input 1102, for example by tokenizing the plaintext input 1102 into a sequence of token identifiers using a tokenizer associated with the MLM 902 and mapping each token identifier to a corresponding embedding vector from a token embedding table stored on the client device 920. The client device 920 maintains a public key 1104 and a private key 1106 for the encryption scheme.

In some aspects, a key generation module on the client device 920 generates the public key 1104 and the private key 1106 as a key pair according to the key generation procedure defined by the encryption scheme, for example by selecting a pair of large prime numbers and computing modular arithmetic parameters in a Paillier key generation process.

The client device 920 retains the private key 1106 in a secure local memory and may transmit the public key 1104 to the server 922 to enable the server 922 to perform homomorphic operations on ciphertexts encrypted under the public key 1104. For each of first operation groups 916a specified in the updated execution plan 1006, an encryption module 1108 on the client device 920 encrypts one or more input values to the first operation groups 916a using the encryption scheme and the public key 1104. The client device 920 transmits the resulting encrypted values 1110, along with any precomputed values (e.g., precomputed output 1008b) needed by the group, to the server 922.

An execution module 1112 at the server 922 executes the operations belonging to the first operation groups 916a using homomorphic operations of the encryption scheme on the encrypted values 1110 to produce encrypted intermediate results 1114. In some aspects, precomputed output 1008a may be included in intermediate results 1114. By way of example, for a group of first operation groups 916a corresponding to a linear transformation layer of the MLM 902, the execution module 1112 may compute a homomorphic matrix-vector product by performing element-wise homomorphic multiplications of each encrypted input value by a corresponding plaintext model weight and homomorphically accumulating the products to obtain an encrypted weighted sum for each output dimension. The server 922 transmits the encrypted intermediate results 1114 back to the client device 920 over a communication channel, such as a secure network connection using a transport layer security (TLS) protocol.

The distributed encrypted execution of first operation groups 916a improves the functioning of the computer system by enabling the client device 920 to offload computationally intensive inference operations to the server 922 without revealing the user-specific plaintext input 1102 or any plaintext intermediate values to the server 922, thereby achieving privacy-preserving inference with reduced client-side computational burden. Because the server 922 operates exclusively on encrypted values and never possesses the private key 1106, a compromise of the server 922 does not expose user data, improving the security posture of the overall computer system.

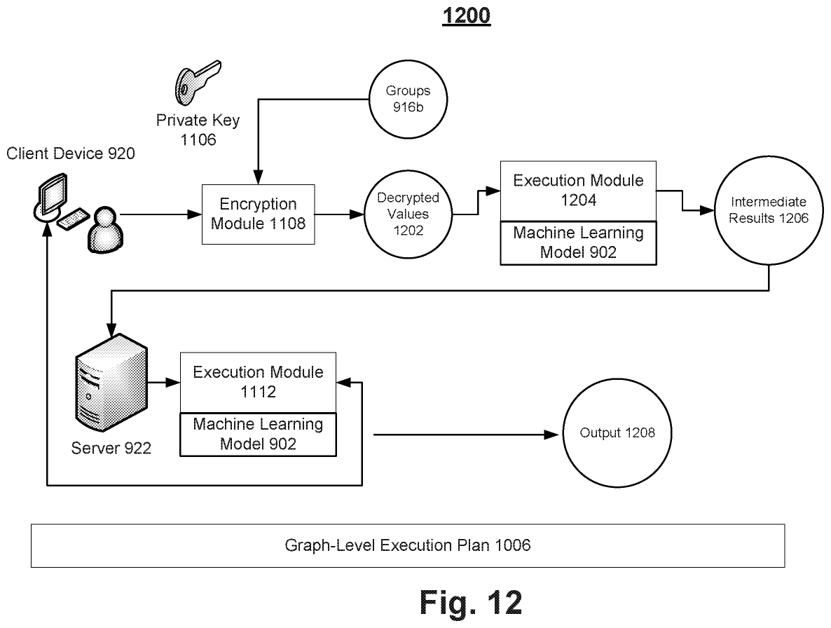

FIG. 12 is a block diagram 1200 depicting runtime execution of second operation groups and iterative transitions between first and second operation groups in the distributed encrypted form.

Referring to FIG. 12, in some aspects, for each group of second operation groups 916b specified in the updated execution plan 1006, the client device 920 decrypts, when necessary, encrypted intermediate results 1114 received from a preceding first operation groups 916a using the private key 1106 to obtain plaintext intermediate values 1202.

An execution module 1204 at the client device 920 executes the operations belonging to the second operation groups 916b on plaintext values at the client device 920. When the updated execution plan 1006 specifies a transition from second operation groups 916b to subsequent first operation groups 916a, the client device 920 uses the resulting plaintext values 1206 as inputs to the subsequent first operation groups 916a, and the encryption module 1108 encrypts those plaintext values 1206 for transmission to the server 922 as described with reference to FIG. 11.

The client device 920 and the server 922 continue executing first and second operation groups in accordance with the updated execution plan 1006 until the MLM 902 produces an output 1208. The client device 920 may present the output 1208 to a user via the user interface, for example by rendering a generated text sequence in a display region of a client application or by converting a sequence of output token identifiers into a natural language string using a detokenizer associated with the MLM 902. The distributed execution thus yields final MLM outputs obtained with a reduced number of encryption and decryption boundaries and minimized remote homomorphic computation.

The iterative alternation between encrypted server-side execution and plaintext client-side execution, guided by the updated execution plan 1006, improves the functioning of the distributed computer system by confining encryption and decryption operations to the minimal set of group boundaries identified during compatibility analysis, rather than encrypting and decrypting at every individual operation boundary, thereby reducing the total number of cryptographic operations and associated network round trips required to complete a single inference pass of the MLM 902.

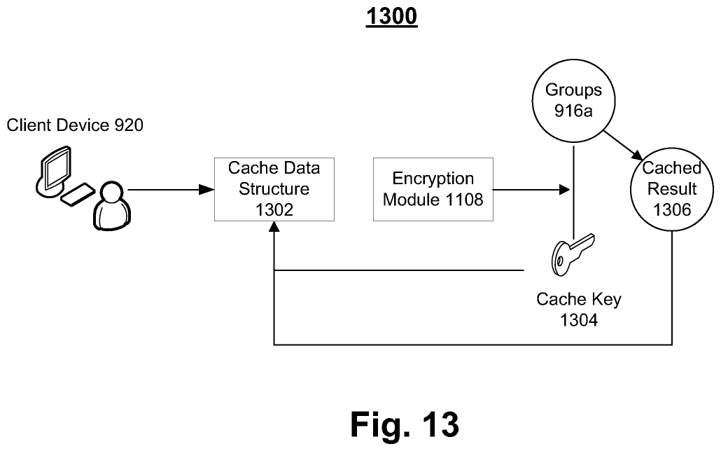

FIG. 13 is a block diagram 1300 depicting optional client-side caching of group-level results at operation group boundaries.

Referring to FIG. 13, in some aspects, the client device 920 maintains a cache data structure 1302 for storing intermediate results associated with previously executed operation groups. For one or more selected operation groups, the encryption module 1108 defines a cache key 1304 that depends on an identifier of the operation group, such as the identifier of one of first operation groups 916a, and a representation of the input state to that operation group, such as a hash or signature of the input values or of corresponding encrypted values.

In some aspects, the cache key 1304 may be computed by applying a cryptographic hash function, such as SHA-256, to a concatenation of the operation group identifier and a byte-level representation of the input values, thereby producing a fixed-length key that uniquely identifies the combination of the operation group and the input state with a negligible probability of collision.

After executing a selected operation group for a given input state, the client device 920 stores in the cache data structure 1302 the cache key 1304 and a cached result 1306 associated with the operation group. The cached result 1306 may comprise an encrypted output associated with the operation group or a plaintext output associated with the operation group.

For subsequent executions of the MLM 902, the client device 920 computes the cache key 1304 for the current input state before executing the selected operation group, determines whether the cache data structure 1302 includes a cached result 1306 for the cache key 1304, and, when a cached result 1306 is present, reuses the cached result 1306 instead of executing the selected operation group.

The client device 920 manages the cache data structure 1302 according to one or more policies, including eviction or invalidation when the underlying MLM parameters are updated, a least-recently-used (LRU) eviction policy that removes the least recently accessed cached result 1306 when the cache data structure 1302 exceeds a predetermined storage capacity, or a time-to-live (TTL) policy that invalidates cached results 1306 after a predetermined duration has elapsed since storage. The client-side caching may thereby reduce computation and communication for operation groups whose input states recur by reusing cached group-level results on the client device 920.

The client-side caching improves the functioning of the computer system by eliminating redundant network round trips to the server 922 and redundant homomorphic computations on the server 922 when the client device 920 encounters a previously observed input state for a given operation group, thereby reducing inference latency, lowering network bandwidth consumption, and decreasing computational load on the server 922 for repeated or partially overlapping inference requests.

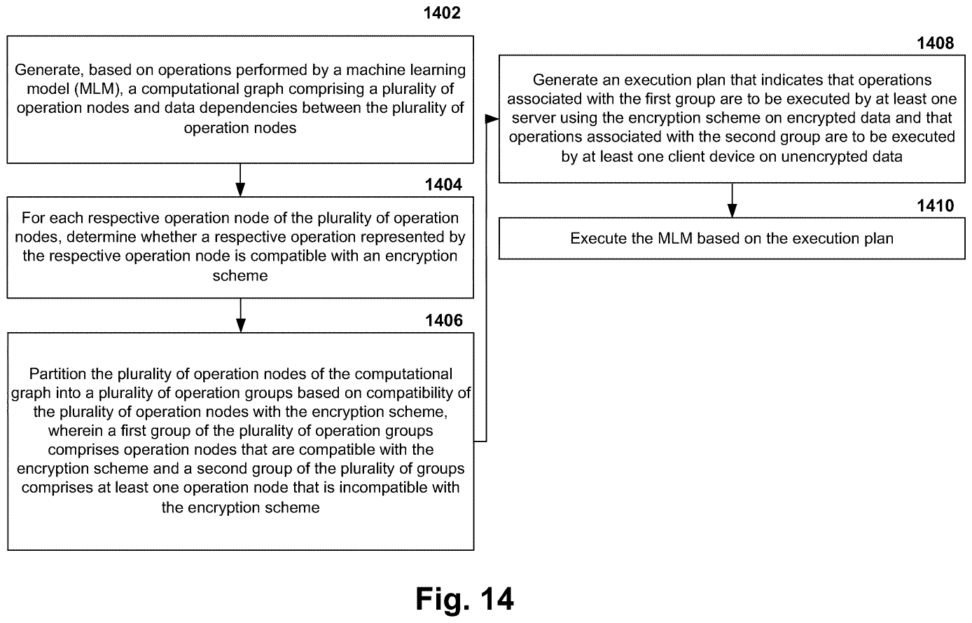

FIG. 14 is a flow diagram of method 1400 for secure distributed execution of ML models using graph-level partitioning under restricted cryptographic capabilities.

At 1402, the operations graph extraction module 904 generates, based on operations performed by an MLM, a computational graph comprising a plurality of operation nodes and data dependencies between the plurality of operation nodes.

For example, consider a 1-bit LLM that processes a three-dimensional input token embedding x=[0.5, −0.3, 0.8] through a simplified transformer layer with a bias vector b=[0.1, −0.2]. The operations graph extraction module 904 traces the MLM's forward pass and produces a computational graph with five operation nodes and a linear dataflow path: N1 (MatMul: multiply 1-bit weight matrix W by x)→N2 (Add: add bias vector b)→N3 (RMSNorm: root-mean-square normalization)→N4 (Softmax: exponentiate and normalize)→N5 (MatMul: multiply 1-bit output weight matrix V by the normalized vector). Each arrow represents a data dependency indicating that the output of one node feeds as input to the next.

In some aspects, the MLM is a 1-bit large language model (LLM), and at least one first operation group comprises operations of a 1-bit linear layer whose weights are quantized to 1-bit precision.

Continuing the example, the 1-bit linear layer in nodes N1 and N5 uses weight matrices whose entries are quantized to {−1, +1}. For instance, W=[[+1, −1, +1], [−1, +1, +1]] (a 2×3 matrix) and V=[[+1, −1], [−1, +1], [+1, +1]] (a 3×2 matrix). Because each weight is either +1 or −1, the matrix-vector product W·x reduces to additions and sign-flips of the input components rather than general-purpose multiplications: row 0 of W·x computes (+1)(0.5)+(−1)(−0.3)+(+1)(0.8)=0.5+0.3+0.8=1.6, and row 1 computes (−1)(0.5)+(+1)(−0.3)+(+1)(0.8)=−0.5−0.3+0.8=0.0.

At 1404, for each respective operation node of the plurality of operation nodes, the graph-level compatibility analysis module 912 determines whether a respective operation represented by the respective operation node is compatible with an encryption scheme.

Continuing the example, the graph-level compatibility analysis module 912 evaluates each node in the graph {N1, N2, N3, N4, N5} against the encryption scheme. N1 (MatMul with 1-bit weights) is flagged as compatible because it reduces to additions and sign-flips. N2 (Add bias) is flagged as compatible because it is a pure addition. N3 (RMSNorm) is flagged as incompatible because it requires a square root and division. N4 (Softmax) is flagged as incompatible because it requires an exponential function and division. N5 (MatMul with 1-bit weights) is flagged as compatible for the same reason as N1.

In some aspects, the graph-level compatibility analysis module 912 determines whether the respective operation is compatible with the encryption scheme based at least part on which arithmetic operations are supported homomorphically by the encryption scheme.

Continuing the example, the encryption scheme supports homomorphic addition, meaning Enc(a)⊕Enc(b)=Enc(a+b), as well as scalar multiplication of a ciphertext by a known constant. The graph-level compatibility analysis module 912 checks each node's underlying arithmetic: N1 and N5 use only sign-flips (scalar multiplication by −1) and additions because of the 1-bit weights, and N2 is a direct addition of the bias vector, so all three are compatible. N3 requires computing sqrt((1.7²+(−0.2)²)/2), which involves squaring and a square root—operations not supported homomorphically—so N3 is incompatible. N4 requires computing exp(·) and dividing by a sum, neither of which is a supported homomorphic addition, so N4 is also incompatible.

In some aspects, the encryption scheme is a partially homomorphic encryption (PHE) scheme that supports homomorphic addition of ciphertexts corresponding to addition of plaintext values.

Continuing the example, under the PHE scheme the client encrypts each component of x: Enc(0.5), Enc(−0.3), Enc(0.8). The server can then compute, for row 0 of W, the operation Enc(0.5)⊕Enc(0.3)⊕Enc(0.8)=Enc(1.6) entirely in the encrypted domain, because PHE supports ciphertext addition corresponding to plaintext addition and scalar multiplication by a known constant (here, multiplying Enc(−0.3) by the scalar −1 to obtain Enc(0.3)). However, the server cannot compute Enc(0.5)⊗Enc(0.5) to obtain Enc(0.25) because the PHE scheme does not support homomorphic multiplication of two ciphertexts, which is why operations involving squaring within RMSNorm are incompatible.

In some aspects, the graph-level compatibility analysis module 912 determines whether the respective operation is compatible with the encryption scheme by determining whether the respective operation can be expressed as a combination of primitive operations that are supported homomorphically by the encryption scheme.

Continuing the example, the graph-level compatibility analysis module 912 decomposes N1 into primitive operations. Because W has 1-bit entries, row 0 of W·x becomes (+1)(x[0])+(−1)(x[1])+(+1)(x[2])=x[0] +(−x[1])+x[2], which is a sum of sign-flipped inputs—each sign-flip is a scalar multiplication by a known constant and each accumulation is an addition, both supported homomorphically. Thus N1 can be expressed entirely as supported primitives. In contrast, RMSNorm (N3) requires computing x[0]²+x[1]² (squaring), then a square root, and then a division, none of which can be decomposed into a combination of additions and scalar multiplications alone, so N3 cannot be expressed as supported primitives.

At 1406, the grouping module 914 partitions the plurality of operation nodes of the computational graph into a plurality of operation groups based on compatibility of the plurality of operation nodes with the encryption scheme. A first group of the plurality of operation groups comprises operation nodes that are compatible with the encryption scheme and a second group of the plurality of operation groups comprises at least one operation node that is incompatible with the encryption scheme.

Continuing the example, the grouping module 914 partitions the five nodes into three operation groups. Group_A (a first group)={N1, N2}, which are the contiguous compatible nodes at the beginning of the dataflow path. Group_B (a second group)={N3, N4}, the contiguous incompatible nodes in the middle comprising RMSNorm and Softmax. Group_C (another first group)={N5}, the compatible node at the end. Group_A and Group_C comprise operation nodes compatible with the encryption scheme, while Group_B comprises operation nodes that are incompatible with the encryption scheme.

In some aspects, the second group comprises at least one operation that uses a non-linear transformation that is not directly supported by the encryption scheme. The non-linear transformation comprises one of: a normalization operation, an exponential function, a Softmax function, or a square root operation.

Continuing the example, Group_B contains N3 (RMSNorm) and N4 (Softmax). RMSNorm is a normalization operation that computes RMS=sqrt((1.7²+(−0.2)²)/2)=sqrt((2.89+0.04)/2)=sqrt(1.465)≈1.21, and then divides each element by RMS to yield [1.7/1.21, −0.2/1.21]≈[1.40, −0.17]. Softmax is an exponential function that computes exp(1.40)≈4.06 and exp(−0.17)≈0.84, then normalizes by their sum 4.90 to yield [4.06/4.90, 0.84/4.90]≈[0.83, 0.17]. Both transformations are non-linear and are not directly supported by the PHE scheme.

In some aspects, the grouping module 914 partitions the plurality of operation nodes into the plurality of operation groups by identifying, along at least one dataflow path in the computational graph, a maximal contiguous sequence of operation nodes that are compatible with the encryption scheme. The grouping module 914 defines the maximal contiguous sequence as the first group such that extending the sequence with an adjacent operation node would introduce an operation node that is incompatible with the encryption scheme.

Continuing the example, the grouping module 914 walks the dataflow path starting from N1. N1 (MatMul, compatible) and N2 (Add, compatible) form a contiguous compatible sequence. The next node, N3 (RMSNorm), is incompatible, so extending the sequence to include N3 would introduce an incompatible node. The grouping module 914 therefore defines {N1, N2} as the maximal contiguous compatible sequence forming Group_A. The walk then continues: N3 and N4 are both incompatible, forming Group_B. Finally, N5 is compatible and stands alone as the maximal contiguous compatible sequence forming Group_C.

At 1408, the grouping module 914 generates an execution plan that indicates that operations associated with the first group are to be executed by at least one server using the encryption scheme on encrypted data and that operations associated with the second group are to be executed by at least one client device on unencrypted data.

Continuing the example, the execution plan specifies: (i) Group_A {N1, N2} is to be executed by the server on encrypted data using homomorphic addition; (ii) Group_B {N3, N4} is to be executed by the client device on unencrypted data because RMSNorm and Softmax are not supported by the encryption scheme; and (iii) Group_C {N5} is to be executed by the server on encrypted data. The plan thus requires two server-side encrypted phases separated by one client-side plaintext phase.

At 1410, the execution module 1112 and/or the execution module 1204 execute the MLM based on the execution plan.

Continuing the example, the execution module 1112 executes the MLM according to the plan: first, the server performs Group_A on the encrypted input to produce encrypted intermediate values [Enc(1.7), Enc(−0.2)]; the client decrypts to obtain [1.7, −0.2] and performs Group_B locally, computing RMSNorm and Softmax to obtain [0.83, 0.17]; the client then re-encrypts this intermediate result and sends it to the server, which performs Group_C to produce the final encrypted output; the client decrypts to obtain the final output [0.66, −0.66, 1.00].

In some aspects, the execution module 1112 executes each operation associated with the first group at the at least one server over the encrypted data using homomorphic operations of the encryption scheme and the execution module 1204 executes each operation associated with the second group at the at least one client device on the unencrypted data.

Continuing the example, the execution module 1112 executes Group_A at the server: given [Enc(0.5), Enc(−0.3), Enc(0.8)], it computes row 0 of W·Enc(x) as Enc(0.5)⊕Enc(0.3)⊕Enc(0.8)=Enc(1.6), then adds Enc(0.1) to obtain Enc(1.7); similarly for row 1, yielding Enc(−0.2). The execution module 1112 also executes Group_C at the server on [Enc(0.83), Enc(0.17)] to produce [Enc(0.66), Enc(−0.66), Enc(1.00)]. The execution module 1204 executes Group_B at the client device: given the decrypted [1.7, −0.2], it computes RMSNorm to get [1.40, −0.17], then Softmax to get [0.83, 0.17], all in plaintext.

In some aspects, the subgraph identification module 1002 identifies, within the computational graph, at least one subgraph whose outputs depend only on model parameters or constants and not on user-specific input data. The subgraph identification module 1002 precomputes one or more outputs of the at least one subgraph as precomputed values. The subgraph identification module 1002 uses the precomputed values when executing operations of the plurality of operation groups without recomputing the outputs for each inference.

Continuing the example, the subgraph identification module 1002 identifies a subgraph consisting of the bias addition portion of N2, because the bias vector b=[0.1, −0.2] depends only on model parameters and not on user-specific input data. The subgraph identification module 1002 precomputes the encrypted bias as [Enc(0.1), Enc(−0.2)] once and stores these precomputed values. For every subsequent inference with a new user input x′, the server reuses the precomputed [Enc(0.1), Enc(−0.2)] in the homomorphic addition step of N2 without the client having to re-encrypt b, thereby saving one encryption round per inference.

In some aspects, the encryption module 1108 encrypts, at the at least one client device, one or more intermediate values that serve as inputs to the first group before execution of the first group at the at least one server. The encryption module 1108 transmits the encrypted intermediate values to the at least one server. The encryption module 1108 then decrypts, at the at least one client device, encrypted intermediate results produced by the at least one server for use as inputs to the second group.

Continuing the example, before Group_A executes, the encryption module 1108 encrypts the input at the client device: [0.5, −0.3, 0.8]→[Enc(0.5), Enc(−0.3), Enc(0.8)], and transmits these encrypted values to the server. The server executes Group_A and produces [Enc(1.7), Enc(−0.2)], which it sends back to the client. The encryption module 1108 decrypts the result at the client device to obtain [1.7, −0.2] for use as input to Group_B. After Group_B completes and produces [0.83, 0.17], the encryption module 1108 re-encrypts these values as [Enc(0.83), Enc(0.17)] and transmits them to the server for Group_C.

In some aspects, the execution module 1112 executes operations of the first group at the at least one server comprises executing at least one of: a matrix-vector operation, a linear projection, or an additive accumulation using a homomorphic addition operation supported by the encryption scheme.

Continuing the example, the execution module 1112 executes Group_A at the server as follows. For the matrix-vector operation in N1, the server computes row 0 of W·Enc(x): (+1)·Enc(0.5)⊕(−1) ·Enc(−0.3)⊕(+1) ·Enc(0.8)=Enc(0.5)⊕Enc(0.3)⊕Enc(0.8)=Enc(1.6), where each scalar multiplication by ±1 and each ⊕is a homomorphic addition operation. For the additive accumulation in N2, the server adds the precomputed Enc(0.1) to obtain Enc(1.7). Analogously, row 1 yields Enc(0.0) ⊕Enc(−0.2) =Enc(−0.2), Completing the Linear Projection Entirely via Homomorphic additions.

In some aspects, the at least one client device caches: a result associated with at least one selected operation group, the cached result being associated with a cache key that depends on an identifier of the selected operation group, and an input state to the selected operation group. The encryption module 1108 determines, for a subsequent execution of the MLM, whether a cache includes the cached result for the cache key corresponding to a current input state of the selected operation group. When the cached result is present in the cache, the encryption module 1108 reuses the cached result without executing the selected operation group according to the execution plan.

Continuing the example, the client device caches the result of Group_B with cache_key=(“Group_B”, hash([1.7, −0.2])) and cached_result=[0.83, 0.17]. On a subsequent inference, if a different user input x′ produces the same intermediate values [1.7, −0.2] after Group_A (e.g., because a repeated token yields the same linear projection output), the encryption module 1108 looks up (“Group_B”, hash([1.7, −0.2])) in the cache, finds the stored result [0.83, 0.17], and reuses it without re-executing the RMSNorm and Softmax computations of Group_B, thereby saving computation on the client device.

In some aspects, partitioning the computational graph comprises identifying a first subgraph whose computations depend on base-model parameters and a second subgraph whose computations depend on tenant-specific adaptation parameters. The first subgraph may include, for example, a set of transformer layer operations whose weights derive from a foundational pre-trained model shared across multiple tenants, such as embedding layers, shared feed-forward projections, and common attention weight matrices. The second subgraph may include, for example, low-rank adaptation (LoRA) layers, adapter modules, or fine-tuned classification heads that encode customizations specific to a particular tenant's domain, task, or confidential training data. Generating the execution plan comprises assigning the first subgraph to server-side execution and assigning the second subgraph to a selectively encrypted branch within the computational graph.

The selective encryption of the second subgraph improves the functioning of the computer system by enabling tenants to retain confidential control over their adaptation parameters while offloading the computationally intensive base-model operations to the server. Because the server executes the first subgraph over encrypted data using homomorphic operations without access to the tenant-specific adaptation parameters, no single party possesses both the base-model inference results and the tenant-specific adaptation logic in plaintext, thereby providing a separation of concerns that enhances data confidentiality in multi-tenant deployment scenarios.

In some aspects, the execution plan specifies a plurality of successive transfers between graph-stage boundaries. The plurality of successive transfers may include transmitting a first intermediate representation to the at least one server for execution of a first linear stage, receiving a transformed representation from the at least one server, and separately executing and exchanging a reduced-dimension adaptation-branch representation for a tenant-specific adaptation stage. By way of example, after the client device transmits an encrypted token embedding to the server, the server executes a first linear stage comprising one or more 1-bit linear transformations and returns a transformed embedding vector to the client device. The client device then executes a tenant-specific adaptation stage comprising a low-rank projection that maps the transformed embedding to a reduced-dimension subspace and applies adaptation weights that encode tenant-specific modifications. The client device may further transmit the reduced-dimension adaptation-branch representation back to the server for integration with subsequent first operation groups.

The use of reduced-dimension adaptation-branch representations improves the functioning of the computer system by decreasing the volume of data transmitted between the client device and the server during each inference request. Because the adaptation branch operates in a lower-dimensional subspace than the full model hidden dimension, the ciphertext payload for adaptation-related transfers is smaller than the payload for base-model transfers, thereby reducing network bandwidth consumption and encryption/decryption overhead while maintaining the confidentiality of tenant-specific adaptation parameters.

In some aspects, determining whether the respective operation represented by the respective operation node is compatible with an encryption scheme comprises classifying a first set of nodes as executable under an additive homomorphic scheme, classifying a second set of nodes as executable under a lookup-based homomorphic scheme, and classifying a third set of nodes as executable under an approximate or multiplicative homomorphic scheme. The additive homomorphic scheme may correspond to a Paillier encryption scheme or another partially homomorphic encryption scheme that supports homomorphic addition of ciphertexts. The lookup-based homomorphic scheme may correspond to a scheme that supports oblivious table lookups or private information retrieval, enabling non-linear function evaluation via encrypted indices into precomputed function tables. The approximate or multiplicative homomorphic scheme may correspond to a fully homomorphic encryption scheme, a somewhat homomorphic encryption scheme, or a scheme that supports approximate arithmetic on encrypted fixed-point or floating-point values, such as the CKKS encryption scheme.

The classification of operation nodes across multiple encryption schemes improves the functioning of the computer system by enabling a finer-grained assignment of operations to the most suitable cryptographic primitive. Rather than treating all encryption-compatible operations uniformly, the graph-level compatibility analysis module 912 may route different portions of the computational graph to specialized encrypted execution paths, thereby reducing the computational overhead associated with overly general homomorphic encryption schemes and enabling the use of more efficient scheme-specific optimizations for each class of operations.

In some aspects, the computational graph comprises an attention node that is incompatible with the encryption scheme in an original form. Generating the execution plan comprises replacing or designating the attention node as a kernel-based attention node having an implementation more compatible with encrypted execution. The original attention node may compute scaled dot-product attention using an attention score matrix derived from query and key projections, a Softmax normalization, and a weighted aggregation over value projections. Because the Softmax normalization involves exponential functions and division operations that are not supported homomorphically by many partial homomorphic encryption schemes, the original attention node may be incompatible with encrypted execution.

The kernel-based attention node replaces the Softmax normalization with a kernel function approximation that expresses attention scores as an inner product in a feature space, such as a random Fourier feature approximation or a polynomial kernel expansion. In such implementations, the kernel-based attention computation may be expressed as a sequence of linear projections and additions that are compatible with additive homomorphic encryption, thereby enabling the attention mechanism to be executed under encryption without requiring the Softmax operation. Alternatively, the kernel-based attention node may employ a linearized attention formulation in which attention is computed by first aggregating key-value pairs and then applying a query projection, thereby decomposing the attention operation into a sequence of encryption-compatible linear operations.

The replacement or designation of attention nodes as kernel-based attention nodes improves the functioning of the computer system by expanding the set of MLM architectures that can be executed under encryption. Conventional transformer-based MLMs rely heavily on Softmax-based attention, which is incompatible with many efficient homomorphic encryption schemes. By substituting kernel-based attention, the disclosed techniques enable server-side encrypted execution of attention-heavy architectures, such as full transformer models, that would otherwise require client-side plaintext execution of every attention layer, thereby reducing the number of encryption/decryption boundaries and network round trips required for inference.

In some aspects, graph partitioning is performed according to both arithmetic compatibility and confidentiality sensitivity of parameters participating in a node or subgraph. Computations that use base-model parameters may be assigned to one server-side graph branch, while computations involving tenant-specific adaptation parameters may be assigned to a selectively encrypted graph branch.

In some aspects, the execution plan defines a staged transfer protocol between graph partitions. A first server-side graph stage may execute a base linear transformation on an intermediate representation received from the client, while a separate reduced-dimension graph branch may be used for a tenant-specific adaptation path, such that a smaller intermediate tensor is exchanged for the adaptation branch instead of encrypting a full hidden-state tensor.

Compatibility analysis may profile a node or subgraph against multiple cryptographic execution models. Additive accumulations and ternary-weight linear operations may be assigned to an additive homomorphic stage; lookup-compatible non-linear approximations may be assigned to a lookup-based stage; and low-depth multiplicative branches may be assigned to an approximate or leveled homomorphic stage.

In some aspects, an attention node that would otherwise require an encryption-incompatible non-linearity may be substituted with or implemented as a kernel-based attention computation that admits lower-depth encrypted evaluation or lookup-based evaluation. A Gaussian-kernel attention formulation is one example.

In some aspects, where a graph node is executed using an approximation selected for encrypted compatibility, the model may be fine-tuned with the approximation substituted into a training or adaptation pipeline so that intermediate values presented to the approximated node remain within an intended approximation range during inference.

It should be noted that the relevant PHE or FHE operations described in the present disclosure may be performed using a dedicated hardware accelerator, including an application-specific integrated circuit (ASIC). The ASIC may include on-chip memory, or alternatively may use memory located outside the chip and allocated for such operations.

FIG. 15 is a block diagram illustrating a computer system 20 on which aspects of systems and methods for providing a secure LLM deployment in an enterprise may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 15 above). Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for secure distributed processing of data, the method comprising:
generating, based on operations performed by a machine learning model (MLM), a computational graph comprising a plurality of operation nodes and data dependencies between the plurality of operation nodes;
for each respective operation node of the plurality of operation nodes, determining whether a respective operation represented by the respective operation node is compatible with an encryption scheme;
partitioning the plurality of operation nodes of the computational graph into a plurality of operation groups based on compatibility of the plurality of operation nodes with the encryption scheme, wherein a first group of the plurality of operation groups comprises operation nodes that are compatible with the encryption scheme and a second group of the plurality of operation groups comprises at least one operation node that is incompatible with the encryption scheme;
generating an execution plan that indicates that operations associated with the first group are to be executed by at least one server using the encryption scheme on encrypted data and that operations associated with the second group are to be executed by at least one client device on unencrypted data; and
executing the MLM based on the execution plan.

2. The method of claim 1, wherein executing the MLM based on the execution plan comprises executing each operation associated with the first group at the at least one server over the encrypted data using homomorphic operations of the encryption scheme and executing each operation associated with the second group at the at least one client device on the unencrypted data.

3. The method of claim 1, wherein determining whether the respective operation is compatible with the encryption scheme is based at least part on which arithmetic operations are supported homomorphically by the encryption scheme.

4. The method of claim 1, wherein the encryption scheme is a partially homomorphic encryption (PHE) scheme that supports homomorphic addition of ciphertexts corresponding to addition of plaintext values.

5. The method of claim 1, wherein the MLM is a 1-bit large language model (LLM), and at least one first operation group comprises operations of a 1-bit linear layer whose weights are quantized to 1-bit precision.

6. The method of claim 1, wherein partitioning the plurality of operation nodes into the plurality of operation groups comprises:
identifying, along at least one dataflow path in the computational graph, a maximal contiguous sequence of operation nodes that are compatible with the encryption scheme; and
defining the maximal contiguous sequence as the first group such that extending the sequence with an adjacent operation node would introduce an operation node that is incompatible with the encryption scheme.

7. The method of claim 1, further comprising:
identifying, within the computational graph, at least one subgraph whose outputs depend only on model parameters or constants and not on user-specific input data;
precomputing one or more outputs of the at least one subgraph as precomputed values; and
using the precomputed values when executing operations of the plurality of operation groups without recomputing the outputs for each inference.

8. The method of claim 1, wherein determining whether the respective operation is compatible with the encryption scheme comprises determining whether the respective operation can be expressed as a combination of primitive operations that are supported homomorphically by the encryption scheme.

9. The method of claim 1, wherein the second group comprises at least one operation that uses a non-linear transformation that is not directly supported by the encryption scheme, the non-linear transformation comprising one of: a normalization operation, an exponential function, a Softmax function, or a square root operation.

10. The method of claim 1, further comprising:
encrypting, at the at least one client device, one or more intermediate values that serve as inputs to the first group before execution of the first group at the at least one server;
transmitting the encrypted intermediate values to the at least one server; and
decrypting, at the at least one client device, encrypted intermediate results produced by the at least one server for use as inputs to the second group.

11. The method of claim 1, wherein executing operations of the first group at the at least one server comprises executing at least one of: a matrix-vector operation, a linear projection, or an additive accumulation using a homomorphic addition operation supported by the encryption scheme.

12. The method of claim 1, further comprising:
caching, at the at least one client device:
a result associated with at least one selected operation group,
the cached result being associated with a cache key that depends on an identifier of the selected operation group, and
an input state to the selected operation group;
determining, for a subsequent execution of the MLM, whether a cache includes the cached result for the cache key corresponding to a current input state of the selected operation group; and
when the cached result is present in the cache, reusing the cached result without executing the selected operation group according to the execution plan.

13. The method of claim 1, wherein partitioning the computational graph includes identifying a first subgraph whose computations depend on base-model parameters and a second subgraph whose computations depend on tenant-specific adaptation parameters, and wherein the execution plan assigns the first subgraph to server-side execution and assigns the second subgraph to a selectively encrypted branch within the computational graph.

14. The method of claim 1, wherein the execution plan specifies a plurality of successive transfers between graph-stage boundaries, including transmitting a first intermediate representation to the at least one server for execution of a first linear stage, receiving a transformed representation from the at least one server, and separately executing and exchanging a reduced-dimension adaptation-branch representation for a tenant-specific adaptation stage.

15. The method of claim 1, wherein determining whether the respective operation represented by the respective operation node is compatible with an encryption scheme includes classifying a first set of nodes as executable under an additive homomorphic scheme, classifying a second set of nodes as executable under a lookup-based homomorphic scheme, and classifying a third set of nodes as executable under an approximate or multiplicative homomorphic scheme.

16. The method of claim 1, wherein the computational graph includes an attention node that is incompatible with the encryption scheme in an original form, and wherein generating the execution plan includes replacing or designating the attention node as a kernel-based attention node having an implementation more compatible with encrypted execution.

17. A system for secure distributed processing of data, the system comprising:
at least one memory; and
at least one hardware processor coupled with the at least one memory and configured, individually or in combination, to:
generate, based on operations performed by a machine learning model (MLM), a computational graph comprising a plurality of operation nodes and data dependencies between the plurality of operation nodes;
for each respective operation node of the plurality of operation nodes, determine whether a respective operation represented by the respective operation node is compatible with an encryption scheme;
partition the plurality of operation nodes of the computational graph into a plurality of operation groups based on compatibility of the plurality of operation nodes with the encryption scheme, wherein a first group of the plurality of operation groups comprises operation nodes that are compatible with the encryption scheme and a second group of the plurality of operation groups comprises at least one operation node that is incompatible with the encryption scheme;
generate an execution plan that indicates that operations associated with the first group are to be executed by at least one server using the encryption scheme on encrypted data and that operations associated with the second group are to be executed by at least one client device on unencrypted data; and
execute the MLM based on the execution plan.

18. The system of claim 17, wherein the at least one hardware processor is further configured to execute the MLM based on the execution plan by executing each operation associated with the first group at the at least one server over the encrypted data using homomorphic operations of the encryption scheme and executing each operation associated with the second group at the at least one client device on the unencrypted data.

19. The system of claim 17, wherein the at least one hardware processor is further configured to determine whether the respective operation is compatible with the encryption scheme based at least part on which arithmetic operations are supported homomorphically by the encryption scheme.

20. The system of claim 17, wherein the encryption scheme is a partially homomorphic encryption (PHE) scheme that supports homomorphic addition of ciphertexts corresponding to addition of plaintext values.

21. A non-transitory computer readable medium storing thereon computer executable instructions for secure distributed processing of data, including instructions for:
generating, based on operations performed by a machine learning model (MLM), a computational graph comprising a plurality of operation nodes and data dependencies between the plurality of operation nodes;
for each respective operation node of the plurality of operation nodes, determining whether a respective operation represented by the respective operation node is compatible with an encryption scheme;
partitioning the plurality of operation nodes of the computational graph into a plurality of operation groups based on compatibility of the plurality of operation nodes with the encryption scheme, wherein a first group of the plurality of operation groups comprises operation nodes that are compatible with the encryption scheme and a second group of the plurality of operation groups comprises at least one operation node that is incompatible with the encryption scheme;
generating an execution plan that indicates that operations associated with the first group are to be executed by at least one server using the encryption scheme on encrypted data and that operations associated with the second group are to be executed by at least one client device on unencrypted data; and
executing the MLM based on the execution plan.
